(19) United States
(12) Patent Application Publication
(10) Pub. No.: US 2010/0320156 A1
(43) Pub. Date: Dec. 23, 2010

(54) Oxidative Treatment Method

(76) Inventors: Charles O. Olaiya, Richland, WA (US); Jennifer E. Holland, Richland, WA (US); Donald H. Alexander, Richland, WA (US); Robert S. Reimers, Metairie, LA (US)

Correspondence Address: Olson & Cepuritis, LTD., 20 NORTH WACKER DRIVE, 36TH FLOOR, CHICAGO, IL, 60606, US

(21) Appl. No.: 12/223,238

(22) PCT Filed: Jan. 25, 2007
(86) PCT No.: PCT/US07/01877

§ 371 Date: Aug. 30, 2010

Related U.S. Application Data
(60) Provisional application No. 60/762,062, filed on Jan. 25, 2006.

(51) Int. Cl. C02F 1/72; C02F 1/50; C23F 1/00; D21C 9/16; C01G 37/02

(52) U.S. Cl. 210/748.1; 210/748.16; 216/83; 162/78; 423/607

(57) ABSTRACT

The present invention provides a method for oxidizing a substance (e.g., in a waste stream, drinking water, a paper pulp slurry, or on a surface), which uses free radicals and reactive species generated from multiple oxidants. The method comprises combining peroxynitrite or peroxynitrous acid and at least one additional oxidizing agent for a period of time sufficient to oxidize the substance of interest. The peroxynitrite or peroxynitrous acid preferably is formed by irradiation of nitrate ion and/or nitric acid (e.g., with UV or gamma rays). The yield of free radicals and reactive species, which are the intermediate species that perform the oxidation may be increased by addition of a catalysts, electromagnetic radiation, sonic waves, and/or electrolysis.

### STATEMENT OF GOVERNMENT INTEREST

This invention was made with governmental support under education grant number EW 1001208 from the United States Department of Energy. The United States government has certain rights in this invention.

### FIELD OF THE INVENTION

The invention relates to methods for oxidizing a substance. More particularly, the invention relates to oxidation methods utilizing a combination of peroxynitrite ion/peroxynitrous acid and at least one additional oxidizing agent.

### BACKGROUND OF THE INVENTION

The U.S. Department of Energy (DOE) has several locations in the U.S. devoted to nuclear and defense research laboratory activities, as well as for underground tank storage of high-level radioactive wastes. The radioactive defense wastes result from many years of defense nuclear weapons production, beginning with what was known as the Manhattan Project. The DOE Hanford Site, which is located in southeastern Washington State on the Columbia River, near Richland, Wash., was established in 1943 as part of the Manhattan Project along with other sites in Los Alamos, N. Mex.; Oak Ridge, Tenn.; and other places such as Savannah River in South Carolina. The Hanford mission was to develop and produce plutonium metal (Pu) for the national nuclear weapons program (Anderson et al., 1979).

Hanford's B Reactor produced plutonium for the bomb used in Nagasaki, Japan, during World War II. Plutonium production continued up to the end of the Cold War era (USDOE, 1990). The collapse of the Soviet Empire in 1988 changed the Hanford mission from processing of reactor fuel for plutonium (Pu) production to waste storage and remediation. Hanford tanks contain waste streams that are highly radioactive containing radionuclides from the chemical separation of various plutonium reprocessing and recovery operations. These waste streams are now currently stored in 177 underground tanks in the 200 Areas of the Hanford Site (Hewlett et al., 1989).

The Hanford Site has 149 underground single-shell tanks (SSTs) built between 1943 and 1963. They were made from reinforced concrete with carbon steel liners, and they each have a storage capacity of 55,000 to 1,000,000 gallons (DOE, 1988b). These underground single-shell tanks at Hanford currently hold approximately 35 million gallons of radioactive waste sludge, saltcake and liquid (DOE, 1991a). Between 1968 and 1989, about 28 underground double-shell tanks (DSTs) were added on the site. These double-shell tanks were made of a carbon steel primary inner tank, an annular space, and a secondary outer tank with reinforced concrete. These tanks were constructed and designed to hold between 1 million and 1.6 million gallons of radioactive waste. The double-shell tanks currently hold about 18 million gallons of highly radioactive waste—mostly liquid, sludge, and saltcake (i.e., slurry). The double-shell tanks are not leaking. Altogether, there are currently 177 underground tanks at Hanford, holding approximately 55 million gallons of radioactive waste.

As reported by DOE, 63 of the single-shell tanks constructed in early 1943 have already surpassed their safety integrity and are suspected or confirmed to have leaked approximately 1 million gallons of radioactive waste into the soil (Garrick et al., 1999, and DOE-RL-98-54, Rev 0. 1998). Also, some of the waste processing has resulted in the release of toxic metals, especially Cr⁺⁶, that are known to be migrating slowly toward the Columbia River aquifer system (DOE 1998b, and Balsey et al., 1997).

Vitrification of radioactive waste is one option for cleaning up sites such as Hanford. Vitrification is a process of blending the waste with molten glass and placing the end product in stainless-steel canisters, some of which will be permanently stored at Hanford. The waste will become stable and impervious to the environment while its radioactivity dissipates over hundreds to thousands of years (USDOE/Bechtel 2004). The project may be the most expensive environmental cleanup effort ever embarked upon in the history of environmental cleanup anywhere in the world. Meeting environmental regulations and HFFACO goals requires the extraction of radionuclides from the waste sludges, and the removal of organic and inorganic compounds and heavy metals (Stewart, et al., 1998, and Resource Conservation and Recovery Act of 1976 [RCRA], 1976).

Chromium exists in three major oxidative states: chromium metal (Cr⁰), trivalent chromium (Cr⁺³), and hexavalent chromium (Cr⁺⁶)—the latter being the most toxic. Hexavalent chromium has been widely shown through animal test models to be a Class A human carcinogen. On the other hand, Cr⁺³ occurs naturally in the environment and serves as a nutrient source for human and animal growth and development. Carcinogenic risks from chromium are known to link to Cr⁺⁶.

Chromium, in particular, has been identified as a potential problem in vitrifying the Hanford tank waste, as it has the potential for increasing the glass waste volume, plugging the feed lines and damaging melter equipment if it is not removed from the high level waste streams before vitrification (Rai et al., 2003). Removal of chromium is an essential processing step because it can precipitate during glass production which can result in a poor quality glass and can even short the melter electrodes.

Because chromium poses challenges to waste vitrification and poses a human cancer risk, its extraction from the tank waste sludge is recognized as one of the essential processes in waste treatment.

Prior art processes have utilized permanganate to oxidize lower valent chromium to more soluble chromium (+6) species. There are several drawbacks to the use of permanganate, however. First, permanganate (MnO₄⁻) adds manganese to the waste processing stream, which increases the volume of glass produced. Permanganate additions are also accompanied by the addition of hydroxide to induce caustic leaching. Secondly, although the use of permanganate has been determined to be more effective than other oxidants to date, it only oxidizes about 70% of the chromium in the waste.

Other types of aqueous systems also benefit from oxidative water treatment methods to destroy or solubilize various contaminants, including organic materials, and various metal-containing compounds. In addition to treatment of waste streams, drinking water can be purified and sterilized by treatment with oxidizing agent, as well.

Accordingly, there is an ongoing need for improved oxidative water treatment methods for purifying waste streams and drinking water. The present invention fulfills this need.

### SUMMARY OF THE INVENTION

The present invention provides a method for oxidizing a substance comprising contacting a substance to be oxidized with peroxynitrous acid and/or a salt thereof (hereinafter referred to collectively as “peroxynitrite ion/peroxynitrous acid”) and at least one additional oxidizing agent in an amount and for a period of time sufficient to oxidize the substance. The at least one additional oxidizing agent can be any suitable oxidizing agent, selected based on the chemical properties (e.g., the redox potential) of the substance to be oxidized. The peroxynitrite ion/peroxynitrous acid preferably is generated by irradiation of nitric acid and/or a nitrate salt (collectively referred to hereinafter as “nitrate ion/nitric acid”) e.g., utilizing UV or gamma irradiation, other forms of ionizing radiation, or any other suitable form of electromagnetic radiation. In addition, a catalyst can be added to enhance oxidation (e.g., to generate additional oxidants such as hydroperoxyl radical, oxygen radials, superoxide, and the like).

In one embodiment, the present invention provides an oxidative method for purification of a waste stream. The method comprises the steps of contacting a waste stream, in an aqueous medium, with peroxynitrite ion/peroxynitrous acid and at least one additional oxidizing agent in an amount and for a period of time sufficient to oxidize at least one selected contaminant present in the waste stream to form at least one oxidation product that is soluble in the aqueous medium; and removing the at least one oxidation product from the waste stream. In preferred embodiments, the at least one additional oxidizing agent is selected from oxidants such as, but not limited to ozone, hydrogen peroxide, permanganate, ferrate, persulfate, an oxidizing halogen species (such as fluorine, chlorine dioxide, bromate, or periodate), peroxyacetic acid, perborate or percarbonate salts, nitrogen dioxide, nitric acid, nitrogen monoxide, superoxide, atomic oxygen, hydroperoxyl radical, hydroxyl radical, other radicals (such as sulfate, carbonate, and nitrate), and a combination of two or more of the foregoing oxidizing agents.

Peroxynitrite ion/peroxynitrous acid can be generated by irradiating nitrate with electromagnetic radiation having sufficient energy to generate peroxynitrite therefrom. For example, the electromagnetic radiation can be ultraviolet radiation, gamma radiation, or a combination thereof. All or a portion of the peroxynitrite can be generated in situ in the waste stream from nitrate (e.g., nitric acid and/or a salt thereof) if desired. If the waste stream is a radioactive waste stream (e.g., a high level radioactive waste), the gamma radiation can emanate from a radioactive component present in the waste stream. Preferably, at least a portion of the peroxynitrite ion/peroxynitrous acid is generated from nitrate ion/nitric acid ex situ and is added to the waste stream after being generated.

In a particularly preferred embodiment, the present invention provides a method for removing chromium from a waste stream. The method comprises the steps of contacting a chromium-containing waste stream, in an aqueous medium, with peroxynitrite ion/peroxynitrous acid and at least one additional oxidizing agent in an amount and for a period of time sufficient to oxidize at least one lower-valent chromium species present in the waste stream to form at least one chromium (+6) species that is soluble in the aqueous medium, and removing the at least one chromium (+6) species from the waste stream. As described above, at least one additional oxidizing agent is selected from oxidants such as, but not limited to ozone, hydrogen peroxide, permanganate, ferrate, persulfate, an oxidizing halogen species (such as fluorine, chlorine dioxide, bromate, or periodate), peroxyacetic acid, perborate or percarbonate salts, nitrogen dioxide, nitric acid, nitrogen monoxide, superoxide, atomic oxygen, hydroperoxyl radical, hydroxyl radical, other radicals (such as sulfate, carbonate, and nitrate), and a combination of two or more of the foregoing oxidizing agents.

The peroxynitrite ion/peroxynitrous acid can be generated by irradiating nitrate ion/nitric acid with electromagnetic radiation (i.e., UV or gamma radiation) having sufficient energy to generate peroxynitrite ion/peroxynitrous acid therefrom, as described above. In chromium-containing high level radioactive waste streams, at least a portion of the peroxynitrite ion/peroxynitrous acid can be generated from nitrate ion/nitric acid utilizing gamma radiation emanating from a radioactive component present within the chromium-containing waste stream. Preferably, at least a portion of the peroxynitrite ion/peroxynitrous acid is generated from nitration/nitrous acid ex situ (i.e., outside the waste stream) and is added to the chromium-containing waste stream thereafter. More preferably, the majority of the peroxynitrite ion/peroxynitrous acid is generated ex situ and is added to the waste stream after being generated. The present methods are particularly useful for solubilizing and removing chromium from water-insoluble components of high level radio active waste streams, such as those found at the Hanford site.

Numerous other wastes will also benefit from the present multiple oxidant invention. A wide variety of recalcitrant and/or toxic organic pollutants are susceptible to destruction by oxidation. For example, chemical weapons compounds such as TNT, RDX, and HMX have been destroyed by oxidation. In addition, chlorinated hydrocarbons that are resistant to biodegradation may be effectively treated by UV/oxidation. Typically, easily oxidized organic compounds, such as those with double bonds (e.g., TCE, PCE, and vinyl chloride), as well as simple aromatic compounds (e.g., toluene, benzene, xylene, and phenol), and recalcitrant molecules such as dioxane and PCB are rapidly destroyed in UV/oxidation processes (U.S. Pat. No. 6,569,353). The design of multiple oxidant technologies can be tailored to most quickly and efficiently decompose each organic molecule or mixtures thereof.

The present invention also provides a method for purifying, disinfecting, and/or sterilizing drinking water. The method comprises contacting drinking water with an oxidatively effective amount of peroxynitrite ion/peroxynitrous acid for a period of time sufficient to oxidize at least one selected contaminant present in the drinking water and to disinfect and/or sterilize the drinking water. Preferably, the peroxynitrite ion/peroxynitrous acid is generated in situ from the existing nitrate or nitrite component of the source water reacting with at least one additional oxidizing agent. The at least one additional oxidizing agent preferably is selected from oxidants such as, but not limited to ozone, hydrogen peroxide, permanganate, ferrate, persulfate, an oxidizing halogen species (such as fluorine, chlorine dioxide, bromate, or periodate), peroxyacetic acid, perborate or percarbonate salts, nitrogen dioxide, nitric acid, nitrogen monoxide, superoxide, atomic oxygen, hydroperoxyl radical, hydroxyl radical, other radicals (such as sulfate, carbonate, and nitrate), and a combination of two or more of the foregoing oxidizing agents. The peroxynitrite ion/peroxynitrous acid preferably is generated by irradiating nitrate ion/nitric acid with electromagnetic radiation (e.g., UV radiation) having sufficient energy to generate peroxynitrous species therefrom.

The present invention additionally provides a method for bleaching waste paper and kraft pulp. The method comprises contacting a pulp slurry with peroxynitrite ion/peroxynitrous acid and at least one additional oxidizing agent in an amount and for a period of time sufficient to oxidize at least one selected contaminant present in the pulp slurry (e.g., lignins and the like), thereby reducing the color of the paper pulp. The concurrently applied combination of ozone and chlorine dioxide (see Toven et al, 2002 and U.S. Pat. No. 6,174,409) has been observed to be more effective than singular use of either oxidant or sequential use of both (see U.S. Pat. Nos. 6,776,876 and 6,210,527) in the delignification of post-consumer waste paper pulp and kraft pulp. Preferably, the at least one additional oxidizing agent is selected from oxidants such as, but not limited to ozone, hydrogen peroxide, permanganate, ferrate, persulfate, an oxidizing halogen species (such as fluorine, chlorine dioxide, bromate, or periodate), peroxyacetic acid, perborate or percarbonate salts, nitrogen dioxide, nitric acid, nitrogen monoxide, superoxide, atomic oxygen, hydroperoxyl radical, hydroxyl radical, other radicals (such as sulfate, carbonate, and nitrate), and a combination of two or more of the foregoing oxidizing agents. The peroxynitrite ion/peroxynitrous acid preferably is generated by irradiating nitrate ion/nitric acid with electromagnetic radiation (e.g., UV radiation) having sufficient energy to generate peroxynitrite species therefrom.

In yet another aspect, the present invention provides an oxidative method for oxidizing and etching a surface of a substrate. The method comprises contacting a surface to be etched with peroxynitrite ion/peroxynitrous acid and at least one additional oxidizing agent in an amount and for a period of time sufficient to oxidizatively dissolve at least a portion of the surface, preferably a selected area of the surface. In a preferred embodiment, the oxidized portion of the surface is solubilized and removed, preferably to a selected and uniform depth. The peroxynitrite ion/peroxynitrous acid preferably is generated by irradiating nitrate ion/nitric acid with electromagnetic radiation (e.g., UV radiation or gamma radiation) having sufficient energy to generate peroxynitrite species therefrom. The at least one additional oxidizing agent is selected based on the chemical properties (e.g., redox potential, acid base properties, solubility, ionic radius, valence state, and the like) of the surface to be etched.

The basic approach is to combine two or more desired oxidants in aqueous solution and then activate them after they are introduced into the solution to be treated according to the following sequence:
1) an oxidant combination (for example a mixture of peroxynitrite, hydrogen peroxide and/or alkali metal peroxide) is selected based on the chemical composition of the surface to be etched or stripped; in some preferred embodiments, the oxidants selected are those with which the atoms of the solid material have the greatest reactivity;
2) the mixture of two or more oxidants is then added to a gelatinous sorbent material comprised of silica gel, alumina gel, and their derivatives, to include but not be limited, to aluminum oxyhydroxides, and silicon oxyhydroxides; in some preferred embodiments, gels containing single oxidants are separately prepared for application to the surface in a serial or concurrent manner, so that the oxidants will mix together on the surface in a selected region;
3) a lithographic mask, comprised of polystyrene or other suitable material, is deposited on the surface;
4) the mixed oxidant gel (or the two or more separately prepared gels) is (are) then applied to the exposed surface to be etched;
5) free radical and reactive species are produced in the gel, or ongoing production thereof is enhanced, by a suitable energy source such as such as ultraviolet, x-ray, or gamma radiation which is applied to the surface to be treated;
6) the gel and the reacted surface material contained therein present on the treated areas within the template are flushed from the surface; and
7) the gel is dissolved and recovered for recycle (see e.g., U.S. Pat. No. 5,547,583 for an example of a recycling process).

Reactive plasma etching, such as remote argon plasma (RAP), is commonly used in the manufacture of semiconductors. It involves the removal of surface material not protected by lithographic masks (commonly formed from polystyrene). Chemically reactive species are applied as the etchant, usually as oxidizing or reducing agents produced from process gases that have been ionized and fragmentized by a glow discharge. These reactive species react with the exposed surface material, removing them from the substrate.

In the present invention, the use of the standard plasma bearing the oxidant is circumvented. Instead the lithographic mask is applied as in the current technology. Subsequently, the mask is covered directly by the mixed-oxide gel. The oxides within the gel are boosted by an energy source such as ultraviolet, x-ray, or gamma radiation producing a surge of free radicals and reactive species directly upon the surface to be etched. In the present invention, stainless steel was etched by free radical production (Holland, 2004). The mixed-oxide gel can then be dissolved and removed and then reapplied until the desired depth is achieved in the areas to be etched (U.S. Pat. No. 5,547,583).

The oxidative methods of the present invention are useful for a variety of applications, including, without limitation, disinfection (e.g., mold removal from surfaces, treatment of drinking water, treatment of wastewater, air purification, such as decontamination of avian flu virus), sterilization (e.g., of medical equipment, food and beverage preparation/storage equipment), decontamination (e.g., destruction of biological warfare agents, air purification), medical treatments (e.g., in oncology for the destruction of tumors, in dermatology for the removal of skin lesions and blemishes, in wound sterilization, antiseptic treatments), cosmetic treatments (e.g., hair bleaching, dental bleaching), agricultural applications (e.g., defoliation, pesticide destruction, washing of fruits and vegetables for disinfection and/or pesticide removal), surface treatments (e.g., etching of semiconductors, stripping/etching of surfaces coated with paints or polymers, etching of metals for artistic production, catalyst regeneration, metal polishing, decontamination of objects exposed to radioactive components, leather tanning pretreatment), separations (e.g., mining, chromate processing, nuclear waste treatment) energy production (e.g., hydrogen production), in situ groundwater treatment (e.g. organic chemical destruction), industrial and municipal wastewater treatment (e.g., organic chemical destruction; deflocculation), air purification and off-gas treatment (e.g., to oxidize volatile organic compounds (VOCs) and oxidation of inorganics), bleaching (e.g., textiles, paper pulp, laundry), chemical synthesis (e.g., epoxidation, dehydrogenation of alkanes, polymerization, oxidation in general), direct treatment of foodstuffs and beverages, and pretreatment of materials for use in fuel cells.

### BRIEF DESCRIPTION OF THE DRAWINGS

FIG. 1 illustrates a schematic representation of a system for oxidizing chromium according to the present invention.

FIG. 2 is a schematic representation of a reactor suitable for use in the methods of the present invention.

FIG. 3 is a graph of chromium oxidation versus time, in the presence of nitrate and 254 nm UV radiation.

FIG. 4 is a graph of chromium oxidation versus time, in the presence of nitrate, peroxide, and 254 nm UV radiation.

FIG. 5 is a graph of chromium oxidation versus time, in the presence of nitrate, peroxide, and 254 nm UV radiation.

FIG. 6 is a graph of chromium oxidation versus time, in the presence of nitrate, peroxide, and 254 nm UV radiation.

FIG. 7 is a graph of chromium oxidation versus time, in the presence of nitrate, peroxide, and 254 nm UV radiation.

FIG. 8 is a graph of chromium oxidation versus time, in the presence of nitrate, permanganate, and 254 nm UV radiation.

FIG. 9 is a graph of chromium oxidation versus time, in the presence of nitrate, permanganate, and 254 nm UV radiation.

FIG. 10 is a schematic representation of the mechanism of chromium oxidation in the presence of nitrate, permanganate, and 254 nm UV radiation.

FIG. 11 is a schematic representation of the mechanism of chromium oxidation in the presence of nitrate, permanganate, and 254 nm UV radiation.

FIG. 12 is a graph of chromium oxidation versus time, in the presence of nitrate, peroxide, and 254 nm UV radiation.

FIG. 13 is a graph of chromium oxidation versus time, in the presence of nitrate, gaseous ozone, and 254 nm UV radiation.

FIG. 14 is a graph of chromium oxidation versus time, in the presence of nitrate, peroxide, gaseous ozone, and 254 nm UV radiation.

FIG. 15 is a graph of hexavalent chromium (produced from chromium (III) oxide) versus time with combinations of ozonated water, potassium permanganate, hydrogen peroxide and 30 mg/L nitrate in the presence of peak wavelength 172 nm UV radiation.

FIG. 16 is a graph of hexavalent chromium (produced from chromium (III) oxide) in the presence of combinations of ozonated water, potassium permanganate, and hydrogen peroxide in the presence of peak wavelength 172 nm radiation.

FIG. 17 is a graph of hexavalent chromium (produced from chromium (III) oxide) in the presence of hydrogen peroxide or permanganate with differing doses of nitrate (0, 30 or 300 mg/L) and irradiated with UV at peak wavelength 172 nm.

FIG. 18 is a graph of hexavalent chromium produced from a dose of 8.2 mg of ozone (600 mL of 13.6 mg/L ozonated water) added to 1 L of 5.0 g/L Cr₂O₃ slurry in the presence of 30 mg/L nitrate and UV radiation at peak wavelength 172 nm.

FIG. 19 is a graph of hexavalent chromium (produced from differing chromium salts) in the presence of differing doses of ozonated water (also with differing pH and ORP), potassium permanganate and 30 mg/L nitrate irradiated with UV radiation at peak wavelength 172 nm.

FIG. 20 is a graph of hexavalent chromium (produced from chromium (III) oxide) in the presence of combinations of ozonated water, potassium permanganate, hydrogen peroxide, 30 mg/L nitrate and anatase titanium dioxide irradiated with UV at peak wavelength 172 nm.

### DETAILED DESCRIPTION OF PREFERRED EMBODIMENTS

Hanford in-tank waste has been characterized and is believed to contain three major waste fractions. The first of these is a high-level waste supernatant aqueous solution, containing dissolved alkaline salts such as the caustic salt sodium hydroxide (NaOH), which can enhance the precipitation of metallic hydroxides. The second waste fraction is also believed to exist in the form of saltcake resulting from periodic evaporation of the liquid supernatant from the precipitating alkaline phase. The solids result from precipitation as the alkaline liquid is evaporated out of the tank to give way to the formation of saltcake and residual supernatant (Krot et al., 1999). The saltcake and residual supernatant can be dissolved by water and pumped to the receiving tanks by a sluicing method, such as is widely used at the DOE sites to immobilize tank waste as well as to reduce the in-tank waste volume.

The third waste fraction is the alkaline actinide metal-bearing sludge waste, which contains uranium fission daughter products such as cesium-137, strontium-90, and techetium-99, as well as organic compounds, and which accounts for a large portion of the radioactivity of the tank waste streams. Most of the heavy metals (e.g., Hg, Pb, Fe, and Cr) present in the DOE waste streams (chromium in particular) were introduced as catalysts to aid in the dissolution of aluminum cladding of fuel tubes, with the primary sources being PUREX and B Plant. (Georgeton et al., DE-AC09-89-SR18035, 1994).

Several laboratory and field tests have been performed at DOE National Laboratories (notably at the PNNL) to determine and accurately characterize the Hanford tank waste matrix. Goheen et al. (2001) conducted analytical lab tests on waste samples from tanks C-104 and AZ-102 to generate data for compliance with leaching of vitrified high-level waste (HLW) finished products, and for a delisting petition for compliance with immobilization of HLW land disposal requirements and restrictions under RCRA.

Chromium is a steel-gray, lustrous, hard, naturally occurring (metal) mineral, first discovered by Vauquelin around 1797 in France. Since its discovery, Cr⁰ has been widely used in various industrial applications. Chromium has an atomic number of 24 and a relative mass of 51.9961, and exists in three major oxidative states, namely: chromium (0), Cr⁰, trivalent chromium (+3), Cr⁺³, and hexavalent chromium (+6), Cr⁺⁶ (ASTDR 2000). Cr⁺³ occurs naturally in our environment and is widely believed to be a nutrient source necessary for the survival of humans, animals and plants. It is an essential natural element needed by the human body for growth and development.

Chromium is found in nearly all of Hanford's 177 tanks (US DOE BBI/TWINs 2002, RPE DQO/RPP-7994 Rev. 2001). The chromium concentration in Hanford waste is estimated to be in the range of about 200 to 300 ppm, based largely on the plutonium production processes known to have been used to produce the waste. Even at this estimated level, chromium still represents a very large mass of the radwaste (i.e., about 272,000 Kg) that must be vitrified.

The most recent oxidative-alkaline leaching and washing of chromium from sludges in Hanford tanks 241-SY-102 and 241-SX-101, using the ultra filtration process to enhance the oxidation of chromium, yielded few or no significant results compared with the previous studies. However, it appears that the application of permanganate with an increased concentration of hydroxide and high temperature (85° C.) slightly enhances the oxidation and yield of Cr⁺³ to Cr⁺⁶ (Rapko et al., Bechtel, 2004). Thus far, the use of permanganate, which leaches manganese (a heavy metal) into the waste stream, has been the most promising method.

A number of studies have been conducted to evaluate means of oxidizing Cr⁺³ to Cr⁺⁶, with the objective of sending most of the chromium to the low-activity waste (LAW) melter. The Waste Treatment Plant Support Project Test Plan suggested that removal of Cr⁺³ by simple alkaline sludge washing or caustic leaching is not an effective or efficient strategy (B M Rapko et al., TP-RPP-WTP-275, 2002, and DOE-EM-0520, 2000). Sludge washing and caustic leaching using dilute hydroxide, removed only ˜20% to ˜45% Cr⁺³. The chromium in the washing solutions was predominantly present as the chromate ion (G. J Lumetta et al., PNNL-12026, 1998).

In the past two decades, several studies have been conducted on Hanford waste sludge to evaluate various means of oxidizing Cr⁺³ to Cr⁺⁶. Other methods of oxidizing Cr⁺³ include, but are not limited to, the use of alkaline hydrogen peroxide and permanganate as oxidizers. Among these prior art methods, the most promising method for oxidizing Cr⁺³ to Cr⁺⁶ is through the use of permanganate, which has its own limitations, however. For example, there is a stoichiometric threshold below which chromium cannot be further removed by permanganate solutions because it leaches manganese into the waste (Rapko et al., -TP-RR-WTP-275 Rev 0. 2003). Rapko and co-workers reported that, when chromium dissolves in the presence of permanganate (Cr⁺³→Cr⁺⁶), especially in an alkaline environment, 1 mole of Cr is leached from the solution. So, also, 1 mole of solid MnO₂ is formed, though such a reaction is limited by the formation of a mixed Cr—Mn complex (Sederburg et al., 2003):

Cr(OH)₃+MnO₄⁻+OH⁻→CrO₄⁻²+MnO₂+2H₂O (Rapko et al., 2003, and Sederburg et al., 2003) (1)

Addition of iron oxide to trivalent chromium (Cr⁺³), on the other hand, reduces chromium leaching to less than 5 mg/L (regulated value) and is most effective at pH 3, the pH used for the Toxicity Characteristic Leachate Procedure (TCLP). However, the pH of the Hanford wastes is around 13.

Ozone (O₃) has also been used to oxidize chromium and other heavy metals. Data presented in the DOE/ORP studies RPP-15552 produced the following results: the solubility of Cr⁺³ is strongly a function of hydroxide concentration and temperature, which may bias the proposed modeling assumptions (Delgard et al., 1993, Rapko et al., 2003, Lumetta and Swanson et al., 1995, Sylvester et al., 2001). Further, ozone has been ruled out because it would be difficult to introduce as a gas (Rapko et al., 2003). Ozone is considered in the present invention because it can be introduced into the waste stream as an ozonated solution and can be deployed as a mixed oxidant.

Nitrate ion is a source of nitrate radicals [NO₃⁻]*, which can form peroxynitrite ion/peroxynitrous acid (ONOO⁻), as illustrated in reaction 2, below. Peroxynitrite ion/peroxynitrous acid is known to oxidize Cr⁺³ to Cr⁺⁶ and thereby enhance the yield of hexavalent chromium.

NO₃⁻+UV→(NO₃⁻)*→ONOO⁻ (Mack and Bolton, 1999) (2)

The formation of an intermediate oxidant (such as nitrate radicals), leading to oxygen evolution has been well studied. For instance, the effect of solutes on the rates of O₂ evolution in the alkaline state above a pH value of 10 indicates that a competition takes place between NO₃⁻ solutes (Shuali et al., 1969; Mack and Bolton, 1999).

(NO₃⁻)*→NO₂⁻+O (Shuali et al., 1969) (3)

(NO₃⁻)*→NO₂⁻+O⁻ (Shuali et al., 1969) (4)

O+NO₃⁻→NO₂⁻+O (Shuali et al., 1969) (5)

NO₃⁻+hv→NO₂⁻+O (Mack and Bolton, 1999) (6)

NO₃⁻+hv→NO₂⁻+O⁻ (O*⁻+H₂O→OH+OH⁻) (Mack and Bolton, 1999) (7)

Notably, hexavalent chromium, in the form of chromate ion (CrO₄⁻²), is the most predominant chromium species found in the Hanford waste sludge. Chromium was introduced to the tank wastes through various industrial-processing applications, and as a corrosion inhibitor and decontaminant, as well as for the dissolution of stainless-steel-clad fuel. It was used to prevent corrosion of stainless vessels and was used in nuclear fuel reprocessing operations.

Chromium usually exists as CrO₃ when in the +6 state, and is relatively stable. When CrO₃ is dissolved in strong acid, it commonly occurs as CrO₄⁻². However, when in a strong base, Cr exists as either Cr(OH)₆ or CrO₃ (CrO₃+3H₂O), since enough hydroxide ion (OH) must exist to satisfy positive charges (Krot et al., 1999).

### Half Cell Potentials of Selected Oxidants in Alkaline Solution

Ozone: O₃+H₂O+2e⁻ [symbol] 2OH⁻+O₂ E⁰=1.24 V (8)

Hydrogen Peroxide: *HO₂⁻+H₂O+2e⁻ [symbol] 3OH⁻ E⁰=0.87 V H₂O₂+2H⁺+2e⁻ [symbol] 2H₂O E⁰=1.776 V (9)

Permanganate: MnO₄⁻+2H₂O+3e⁻ [symbol] MnO₂+4OH⁻ E⁰=0.588 V (10)

Glaze et al. (1989) developed a kinetic model for oxidizing hazardous materials (micropollutants) in aqueous media using the combination of ozone and peroxide to generate hydroxyl radicals. Cotton et al. (1999) explained the state of chromium chemistry as follows: When chromium is at pH above 6, Cr⁺⁶ oxide (CrO₃) forms chromate ion CrO₄²⁻. Between pH 2 and 6, HCrO₄⁻ and dichromate ion Cr₂O₇²⁻ are in equilibrium. When the pH values are <1, the main chromium species is H₂CrO₄. The general principle above for chromate and dichromate ions further illustrates the following reactions:

HCrO₄⁻ [symbol] CrO₄²⁻+H⁺ pK₂=6.49 (11)

H₂CrO₄ [symbol] HCrO₄⁻+H⁺ pK₁=0.74 (12)

Cr₂O₇⁻²+H₂O [symbol] 2HCrO₄⁻ K=10^{-2.2} (13)

Cr₂O₇⁻²+H₂O [symbol] 2CrO₄²⁻+2H⁺ K=10^{-13.7} (14)

Another general assumption is that, in oxygen-bearing waters, depending on the pH, the predominant form of chromium is Cr^{+6.} At pH between about 1.7 and 1.6, Cr⁺⁶ is in the form of HCrO₄⁻². At pH of about 6.1 and above, the Cr⁺⁶ is in the form of CrO₄⁻². At pH below about 1.7, Cr⁺³ is predominant in the form of CrOH⁺². In anoxic groundwater, chromium is predominantly present in the form of Cr⁺³. At a pH of ˜4.8 and below, Cr⁺³ is in the form of CrOH⁺². At pH ˜4.8 and 13.2, Cr⁺³ is in the form of Cr₂O₃. At pH's above 13.2, Cr⁺³ is in the form of CrO₂⁻ or Cr(OH)₄⁻¹ if hydrated (Cotton et al.).

Therefore, to remove chromium from wastewater, the pH and adjustment of the wastewater constituents must be considered along with the concentrations and the oxidative states of the chromium to be removed. Chromium oxidation can be elucidated as follows: hydrous Mn(III, IV) oxides can be used for oxidation of oxidizable trace elements. The oxidation of Cr⁺³ is very slow to react with oxygen, but Cr³⁺ has a relatively rapid adsorption rate with the Mn(III, VI) oxide and can be rapidly oxidized:

| | Oxidation State | Compounds |
|---|---|---|
| (15) | Cr⁺⁶ | CrO₄²⁻, CrO₂Cl₂, CrO₃ |
| (16) | Cr⁺⁵ | CrO₄³⁻ |
| (17) | Cr⁺⁴ | CrO₃²⁻, CrO₂ |
| (18) | Cr⁺³ | Cr(OH)₃, Cr₂O₃ |

Many of the methods for removing chromium, including in situ vitrification, have been deployed in the field as well as in laboratory settings, with remarkable success (Siegrist et al., 2003). However, the ozonation method, despite the fact that it has been successfully used in the treatment of wastewater sludge, has not been widely applied to extract chromium from radioactive waste sludge. Rapko, et al. (2003) state that the ozonation method has had remarkable success in oxidizing chromium from wastewater and municipal waste streams, but has yet to be successfully deployed to further oxidize chromium from radioactive waste streams.

The concentrations of oxidizable or reducible species may be sometimes unpredictable and far from those predicted thermodynamically (Skoog et al., 1974). Accurate assessment of the thermodynamic properties of wastewater and waste sludge are dependent on pH and oxidation-reduction potential, or ORP. (Stumm et al., 1996). Kinetic redox reactions occur constantly in the mixture of wastewater and waste sludge constituents—especially for chromium, which is susceptible to speciation changes.

In principle, an oxidant is a substance that causes oxidation to occur as indicated by the following several half-reactions (Stumm et al., 1996):

O₂+4H⁺+4e−=2H₂O (Reduction) (20)

4Fe²⁺=4Fe³⁺+4e− (Oxidation) (21)

O₂+4Fe²⁺+4H⁺=4Fe³⁺+2H₂O (Redox reaction) (22)

In simple terms, the basic principle of oxidation-reduction (redox) refers to any chemical reaction involving the positive charge and removal of electrons (oxidation); on the other hand, reduction is the decrease in the valence state of an atom by adding electrons. Chromium can reverse its oxidation state by reduction from the hexavalent to the trivalent oxidation state as follows:

CrO₄⁻²+8H⁺+3e⁻→Cr⁺³+4H₂O (23)

The trivalent chromium is a known non-toxic, naturally occurring form of oxidized chromium, which can be immobilized by precipitation and adsorption:

Cr⁺³+30H⁻→Cr(OH)_{3.} (24)

In principle, the reactions reverse one another; e.g., the chemical reactions between the permanganate ion and hydrogen peroxide, which reverse each other, form another classic example of redox reactions as follows (Heckmann et al., 1978):

2MnO_{4 (aq)}⁻+H₂O_{2(aq)}+6H⁺_{(aq)}→2Mn²⁺+3O_{2 (g)}+4H₂O₍ₗ₎ (25)

2MnO_{4 (aq)}⁻+3H₂O_{2(aq)}+6H⁺_{(aq)}→2Mn²⁺_{(aq)}+4O_{2 (g)}+6H₂O₍ₗ₎ (26)

In the waste sludge and wastewater treatment industry, the permanganate anion (MnO₄⁻) is a popular oxidant, which has been used successfully for years to oxidize and extract chromium from waste sludge and for wastewater treatment, and water purification (Siegrist et al., 2003; Englande et al., 1978). Much of the literature on removal of heavy metals like manganese shows that heavy metals can be extracted by chemical precipitation. Furthermore, heavy metals have been removed from wastewater by iron flocculation and coagulation, spray aeration, and manganese filtration with contact with activated carbon. Where lime soda treatment facilities are lagging, manganese is best removed by aeration, though this method has been improved upon and replaced by manganese zeolite (Cadman et al., 1980). Therefore, in precipitating chromium in the tank waste sludge and/or in soil contaminated by redox processes, reduction of Cr⁺⁶ is an essential focus of the environmental chemistry of chromium.

The complexity of chromium in the Hanford waste matrix requires a pretreatment phase, as well as an understanding of the behavior and redox reactions of chromium vis-à-vis other compounds in the waste sludge, before the waste streams are sent for vitrification. In other words, the chemical composition of the tank waste will drive the types of redox reactions that will occur. The dissolution and separation of waste constituents such as chromium from the waste sludge requires additional understanding of the in-tank waste sludge chemistry as well. In general terms, the removal of chromium can be influenced by its oxidation state and initial concentration. It is known, however, that Cr⁺⁶ is more soluble and mobile than Cr⁺³.

Englande and Reimers (1978) conducted a study assessing several methods to trace and extract heavy metals from wastewater for wastewater reuse. Hydroxide ions were observed to readily react with Cr⁺³, precipitating hydroxide that was dissolved in excess base. It removed over 50% of the chromium in physical-chemical and AWT systems. Coagulation was adopted in the study to trace and recover some types of heavy metals from the wastewater, and that process was reported to be effective for those particular metals. In their wastewater reuse study, Englande and Reimers also applied a filtration process for the extraction of heavy metals from wastewater, and the study showed that filtration was only effective in removing Cr⁰ and not Cr⁺⁶. The carbon adsorption method was reported to have been more effective, and it progressively reduced Cr⁺⁶ to non-toxic Cr⁺³ due to chemical and biological activity within the carbon column.

Lash et al. (1975) indicated that adding iron to chromate wastes increases the quantity of sludge that is precipitated. Considering the 2.5 times theoretical dosage of ferrous sulfate required, approximately 15.2 parts of sludge are precipitated per part of chromium reduced. One part of chromium is equivalent to 1.98 parts of chromic (Cr⁺⁶) hydroxide, meaning that the total quantity of sludge produced contains 17.2 parts of chromium, as compared with 1.98 parts per million of chromium when sulfite is used as the reducing agent and the pH is raised to about 9.0 to precipitate chromic hydroxide. In some certain situations, iron has been used as a reducing agent, reducing Cr⁺⁶, a toxic and known human carcinogen, to Cr⁺³ non-toxic (nutrient) under certain favorable conditions as shown in the redox reactions below (Fendorf et al., 1996):

Cr⁺⁶+Fe⁺² [symbol] Cr⁺⁵+Fe⁺³ (27)

Cr⁺⁵+Fe⁺² [symbol] Cr⁺⁴+Fe⁺³ (28)

Cr⁺⁴+Fe⁺² [symbol] Cr⁺³+Fe⁺³ (29)

Buerge et al. (1997) and co-investigators studied the kinetics and dependency of Cr⁺⁶ pH reduction by Fe⁺², where pH values were between 2 and 7.2, using UV-VIS spectroscopy and multi-component fitting to determine the rate constant for Cr⁺⁶ reduction. The study indicates that, under acidic conditions, the reduction rate can increase with the decrease in pH, even when the pH rises above 4. Their study indicated that all reduction experiments between pH 4.4 and pH 7.2 exhibit overall second-order kinetics, as recorded in their report as follows:

−d[Cr⁺⁶]/dt=(K₁[Fe²⁺)]+K₂[Fe(OH⁺)]+K₃[Fe(OH)₂])[Cr⁺⁶] (Buerge, et al., 1997) (30)

The Buerge study indicated that kinetic expression and pH dependency of Cr⁺⁶ reduction by Fe⁺² oxygenation showed that Cr⁺⁶ oxidizes Fe⁺² faster than O₂ by a factor of 3×10⁴ at pH 4.6, and 1×10³ at pH 8. Buerge did a follow-up to the 1997 study on kinetics and pH dependency and the reduction of Cr⁺⁶ by Fe⁺².

Buerge et al. (1998) reported the influence of organic ligands on Cr⁺⁶ reduction by a series of Fe⁺² organic complexes using UV-VIS spectroscopy and kinetic fitting. The purpose was to determine the rate constant for Cr⁺⁶ reduction using 1-20 μM Cr⁺⁶, 1-60 μM F^{e+2}, 5-1000 μM, soil extraction (collected), and organic ligands at pH 4.0-5.5. The study revealed that the presence of organic ligands leads to soluble Cr⁺³ and Fe⁺³ complexes, representing a significant reduction rate for Cr⁺³ in DOC-rich soils and natural water environments. The following equations explain more of the Buerge et al. experiment and study:

−d[Cr⁺⁶]/dt=Σ_{L}(k_{L}[Fe⁺²L][Cr⁺⁶]. (31)

−d[Cr⁺⁶]/dt=+(k₁[Fe⁺²]+k₂[Fe(OH⁺)]+k₃{Fe(OH)₂⁰])[Cr⁺⁶] (32)

Where k_{L} is pH-dependent, Fe⁺²-stabilizing ligands such as bi- and multi-dentate carboxylates and phenolates generally accelerate the reactions, whereas Fe⁺²-stabilizing ligands such as phenanthroline essentially stop the reaction.

The initial concentration for most solutions reported by Buerge and co-investigators seemed not to satisfy the usual excess condition for classical kinetic analysis. On the other hand, redox reactions from Buerge et al. study indicated that the presence of micromolar Cr⁺⁶ and Fe(II) reacted quickly as insoluble products above pH 3 which suggested that the presence of carboxylates and phenolates can lead to acceleration rates and formation of complexed soluble Cr⁺³.

The Buerge et al. study provides a quantitative understanding of the reduction rate of Cr⁺⁶ by Fe⁺² in a DOC-rich environment. The study also suggests that, in a Cr⁺⁶ contaminated environment, available Fe(VI) will readily be consumed, and Fe⁺² may not be sufficient to remove all Cr⁺⁶. In principle, the study indicates that Fe⁺² is a potent agent for remediation of a Cr⁺⁶-contaminated site and the treatment of industrial waste sludge and wastewater.

Fleischman (1993) has reported that Ag⁺² ions are effective oxidizing agents that are known to be more effective because they oxidize many organic and inorganic compounds rapidly. However, they are cost-ineffective oxidizing agents when the ionic agents are electrochemically oxidized, because large amounts of power are needed to produce the Ag⁺² ions.

The term “pH” is defined as the negative log of hydrogen ion concentration, which can also be expressed as pH=−log [H⁺]. The general principle of pH values has been that low pH values correspond to high concentration of H⁺, and high pH values to low concentration of H⁺ (Murray et al., 1993). The term “Eh” is the oxidation-reduction potential measured in volts.

The ability to predict and thermodynamically understand the behavior of the waste sludge may depend on the ability to measure the pH and Eh of the waste stream. The separation of chromium from waste sludge must account for the pH and Eh of the system. The predominant species of relevance to the current invention involve the oxidation of Cr⁺³ to Cr⁺⁶.

Cr⁰₍ₛ₎+2OH⁻→Cr⁺²(OH)₂+2e⁻ (33)

Cr⁺²(OH)₂+OH⁻→Cr⁺³(OH)₃+e⁻ (34)

Cr⁺⁶(OH)₃+OH⁻→Cr⁺⁶O₄⁻²+4H⁺+3e⁻ (35)

The Tulane Advanced Oxidation Process (TUOAP) reactor design was used, with modifications, to implement the oxidation of chromium from the Hanford radwaste simulant solutions according to the methods of the present invention. The TUOAP mixed oxidant delivery system was originally developed by J. Holland at Tulane University to treat municipal wastewater (J. Holland et al., 2004).

Reconfiguration of the TUAOP mixed oxidant delivery system was needed in order to utilize the system for radwaste solutions. The Advanced Oxidation Process (AOP) method was retrofitted with a simple reactor vessel. The adaptation of the new reactor vessel allowed the use of low- and medium-pressure mercury UV lamps to provide electromagnetic radiation below about 254 nm.

Major modifications of the TUAOP process and apparatus included: the use of a different reaction vessel; the encasement of a 500 mL or 1000 mL beaker with stirrer; and the insertion of pH and oxidation-reduction potential (ORP) probes for measuring the pH and redox levels while reactions were taking place.

This reactor design allowed a UV lamp to be mounted at the top of the system so that light could be directed onto the simulated radwaste sample. The reconfigured TUAOP reaction vessel allowed the rapid and efficient injection and retrieval of samples.

### Materials and Methods.

The reagents and materials utilized in the following examples include potassium permanganate (crystalline), chromium potassium sulfate, sodium bisulfite, sodium hydroxide, hydrogen peroxide, sodium nitrate, chromium oxide (sesquioxide), potassium hydroxide, EDTA 50% w/v, potassium dichromate, sodium peroxide (30% and 50% conc.), quinhydrone, chromium trioxide, sodium oxalate, 1,5-diphenyl carbazide, and chromaVer3 chromium reagent powder pillows purchased from HACH USA. A HACH DR/2010 spectrophotometer and sample cell 25-mL beakers were purchased from HACH USA as a means of determining chromium oxidation. An AR25 dual channel pH/ion meter from Fisher Scientific was used to monitor pH. A low-pressure mercury ultraviolet lamp (HOK4-120/SE-low pressure UV lamp and HOK 4-120SE connector ballast) manufactured by Philips, or a Bluelight Eximer UV lamp with a peak wavelength of 172 nm (from Heraeus Noblelight) was used to photo-oxidize the simulant solutions. Distilled water was supplied by Abita Spring Water Corporation, New Orleans, La. All reagents were A.C.S. certified and were purchased from Fisher Scientific Corporation in Houston, Tex.; LABCHEM, Inc.; Sigma-Aldrich in St. Louis, Mo.; and ACROS Organic, Inc. in New Jersey.

The reaction vessel used in these examples was manufactured by Mechling's MHD Systems, Inc., Bogalusa, La. The reaction vessel was made of PVC, with a Lucite plastic bottom. The top plate (lid of the reaction vessel) was made of T304 stainless steel, designed to allow the 16-mm-diameter, low/medium-pressure mercury HOK 4/120 SE UV lamp to be mounted and to penetrate the solution while the experiment was taking place. Also, the mixed oxidant delivery system included an O₂ tank and chiller, both of which were connected to the ozone generator, and an API ozone monitor.

Ozonated water was produced by bubbling ozone gas at ˜10% wt (produced from medical grade pure oxygen feed gas by a Pacific Ozone Technology (Benecia, Calif.) Lab Series Generator) into a flask of distilled water with a Fisher Scientific fritted Pyrex diffuser (nomial pore size of 40-60 microns).

The media for the control and exemplary experiments were prepared in large batches so that each of the slurries were available for each experiment, and for assuring comparable results. In preparing the reagents, permanganate concentrations were selected to be the same as those used by Sederburg et al., 2003 and Rapko et al., 2004 to allow comparison to their studies. Therefore, 0.1M and 0.3 M [MnO₄⁻] solutions of permanganate were prepared to provide a basis of comparison with the experiments of Rapko et al., 2004.

The preparation of permanganate requires standardization with sodium oxalate (acidic). In standardizing KMnO₄ solution, 1.500 g of sodium oxalate (Na₂C₂O₄) was dried for about an hour in an oven with the temperature set at 110° C. The oxalate was allowed to cool, and three samples of 0.2000 g each (weighed to 0.1 mg) of N₂C₂O₄ were weighed and introduced to each beaker of 400 mL that contain 250 ml of 1.0 M of H₂SO₄. Each sample was dissolved in the 250 mL of 1.0 M of H₂SO₄. This procedure was employed in permanganate used in conjunction only with experiments in which gaseous ozone and 254 nm UV irradiation were used.

The sample solution in each beaker was heated to between 80° C. and 90° C. and titrated with the selected permanganate standard solution as the pink color appeared and faded out within 2 seconds, while keeping an eye on the thermometer to make sure that the temperature did not drop below 60° C. Although more permanganate was added for another 30 seconds, no additional reaction took place. The means of standardizing permanganate is given in the following equation:

5Na₂C₂O₂+2MnO₄⁻+6H⁺→2Mn⁺²+10CO₂+8H₂O (42)

Solutions of chromium hydroxide, Cr(OH)₃, of 0.1 M, 0.3 M, 0.5 M, 1.0 M and 3.0 M were prepared as slurries for all the experiments from chromium potassium sulfate (salt) of A.C.S grade (CrK(SO₄)₂.12H₂O.

Individual concentrations were weighed on a scale, placed in a large beaker and diluted with distilled water. The appropriate amount of sodium hydroxide (solid) was introduced to the (CrK(SO₄)₂.12H₂O solution already dissolved in the beaker. For example, in preparing 0.3 M of Cr(OH₃), 419.82 g of CrK(SO₄)₂.12H₂O was weighed and placed in a 1 liter beaker as the reagent was dissolving with the aid of a magnetic stir plate. As the Cr⁺³ salt was dissolving in 1 liter of distilled water, the same ratio of 0.3 M [OH⁻] was introduced until the simulant solution arrived at a pH of about 13.0. The preparation of simulant solution followed the same process.

In some cases, in the preparation of the slurries, the addition or release of more sodium hydroxide was required adjustment of the simulant solution to pH 13. Calculation for such an adjustment was made and documented in the test run. The preparation of slurries for the exemplary experiments were prepared primarily as Cr(OH)₃ to represent the Cr⁺³ from CrK(SO₄)₂.12H₂O salt:

CrK(SO₄)₂+3NaOH→(Na)₃K(SO₄)₂+Cr(OH)₃ (43)

Hydrogen peroxide (H₂O₂) was purchased as a prepared solution at 30% or 50% A.C.S grade and concentration, and used for the experiments as such. Depending upon the experiment, the appropriate ratio and amount of peroxide was introduced. Other reagents such as ethylenediaminetetraacetic acid (EDTA), and sodium nitrate (NaNO₃) were also used as purchased.

Titration: The standard redox titration setup required the use of a burette, a pipette, and a stirrer plate on which a 500 mL beaker of simulant solution resided. The redox titration setup allowed the use of pH and ORP probes to measure the reactions that were taking place during the progress of titration.

Spectrophotometry: A standard HACH DR2000 spectrophotometer setup was used to observe the oxidation of chromium after the residue is removed by centrifugation and filtration.

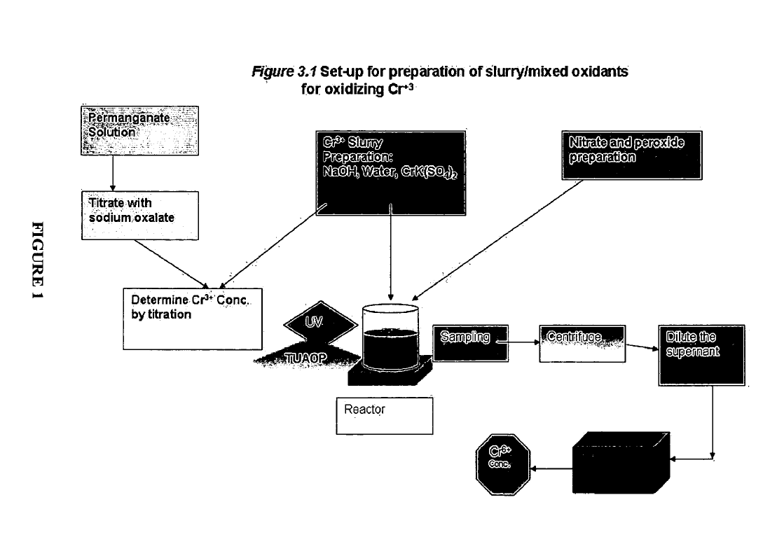

All experiments were conducted under a fume hood to avoid exposure or skin contamination, because the end product in all the experiments was Cr⁺⁶, a known human carcinogen. FIG. 1 provides a schematic of the general experimental approach and arrangement.

Control Experiments: The control experiments were designed to establish comparison and control conditions for comparison with previous studies. All experiments were conducted in an alkaline solution (0.1 M [OH], 0.3 M [OH], and 3.0 M [OH]) for comparison to the results of Sederburg et al., 2003, and Rapko et al., 2003. The first method required a direct, simple redox titration method with 0.1 M [MnO₄] and 0.3 M [MnO₄].

Standard titrations were conducted after a thorough cleaning of burette, flask and other apparatus to assure that no liquid remained on the side of the burette that would introduce error into the sample's volumetric measurements.

The 50 mL burette was filled to the top and the stopcock valve and was released to allow a few milliliters of the stock solution to run through in a separate empty flask until all the air was purged. Then the stopcock valve was closed and the initial volume on the burette was read before starting the actual test and titration.

In the reaction vessel (500 mL beaker), 250 mL of 0.1 M Cr(OH)₃ simulant solution was carefully drawn, measured, and placed directly into the 500 mL beaker sitting on the magnetic stirrer plate. Stirring was initiated prior to titration, so that a thoroughly mixed simulant solution could be achieved. The spectrophotometric measurement required that the simulant solution be prepared to suit the spectrophotometer system.

As described above, the simulant solution of choice consisted of concentrations of 0.1 M and 0.3 M for MnO₄⁻ and 250 mL of prepared Cr(OH)₃, which were weighed in a clean beaker and the pH and ORP measurements were determined to be in the range of about 13 before the reaction was started. The 250 mL simulant solution beaker was placed inside an encased reaction vessel inside the fume hood. A pre-established amount of (0.1 M) MnO₄⁻ stock solution was measured and introduced to the simulant solution. The control experiment, like the rest of the other spectrophotometer experiments that were performed, conformed to the following process:
(1) Measure specific amount of already prepared Cr(OH)₃ radwaste simulant solution (e.g., 0.1 M, 0.3M) which represents the Cr⁺³ concentration of concern.
(2) Place the Cr(OH)₃ simulant solution in a clean 500 mL beaker.
(3) Place the beaker on an encased magnetic stir plate.
(4) Calibrate the pH and ORP probes.
(5) Make sure the pH of the simulant solution still remains in the pH range of ˜13. Ensure that the stirrer is working and that the lid where the low pressure UV lamp is attached is tightly closed.
(6) Weigh the amount of permanganate stock solution needed for the experiment and release the measured amount of permanganate stock solution.
(7) When nitrate is used, weigh the nitrate and release it to the simulant solution.
(8) When oxidants such as hydrogen peroxide (H₂O₂) are to be introduced to an experiment, measure the ratio needed with a pipette. Pipette directly from the solution container.
(9) When ozone is needed as an oxidant, use the O₂ source by connecting it to the ozone generator and run through O₂/O₃ line.
(10) Activate the UV light.
(11) Set the timer for each experiment for the appropriate time interval.
(12) Extract a sample every 5 minutes from the reaction vessel with a 10 mL pipet.
(13) Each sample is withdrawn at each 5-minute interval to measure pH and ORP.
(14) Transfer the 10 mL sample and place it in the centrifuge to separate the residue from the liquid phase.
(15) Withdraw with pipette a 1000 μg/l sample; transfer the sample solution to a 50 mL flask and dilute it with distilled water up to the 50 mL mark. (Yellow color should show depending on the amount of Cr⁺⁶ that is present.)
(16) With the pipette, draw a sample from the 50 mL flask that has already been diluted with distilled water. Draw the appropriate concentration (e.g., 25, 50, 100, 1000 μg/L) depending on the choice and concentration of the sample to be tested in the spectrophotometer.
(17) Transfer the drawn sample to the spectrophotometer and dilute finally to 25 mL.
(18) Discharge one Chroma Ver 3 reagent powder pillow to the sample in the spectrophotometer cell, invert gently. Within a few seconds a pink color will show, indicating the presence of chromium. With this indicator, wait for 5 minutes to allow completion of the reaction.
(19) Calibrate the spectrophotometer (HACH DR/2010 540 nm) by locating the number for the chromium measurement, which is 90.
(20) Open the spectrophotometer lid to set the calibration by filling a cell bottle with distilled water to the 25 mL mark, place the cell in the spectrophotometer and close. Press “read,” wait for about 10 seconds, and the machine will give a zero reading in mg/Cr⁺⁶. The zero reading indicates that no Cr⁺⁶ is present in the water.

The spectrophotometer used for these studies could only measure up to the maximum of 0.6-0.7 mg/L Cr⁺⁶.

Generation of ozone was initiated by the O₂ tank, which was connected to the ozone generator, run through O₂/O₃ line and pumped to the simulant solution in the reaction vessel.

The flow of the O₂ and the formation of O₃ was observed and documented by reading the number coming out of the ozone generator panel, which can vary from 0.97 to 2.56 API. (This number represents the ozone concentration produced and is in either ppb or % wt of the ozone produced).

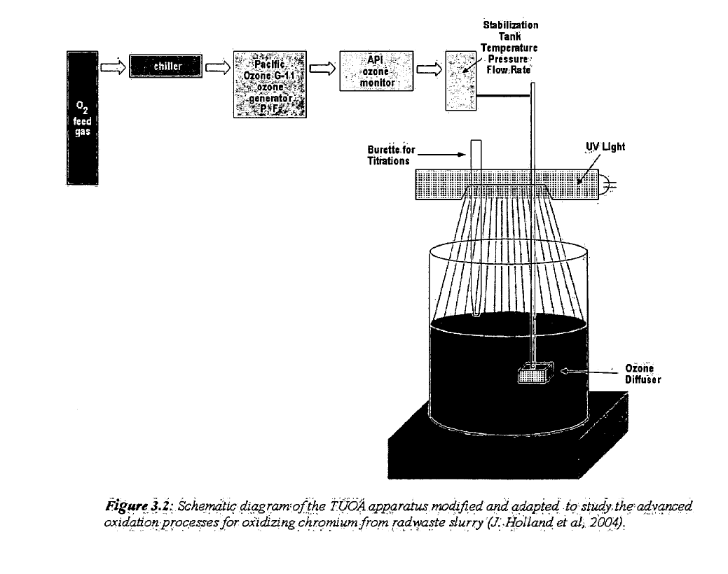

The setup for the spectrophotometer, shown in FIG. 2, required a known complex calibration method that starts with the setting of the apparatus at 90 for measuring hexavalent chromium. The apparatus operates on a 540 nm range for chromium and other heavy metals. Before any chromium sample was measured, the spectrophotometer was first tested and calibrated with distilled water to set the machine to zero mg Cr⁺⁶/L. The setting of the spectrophotometer to zero mg/L Cr⁺⁶ is important, as it indicates no chromium hexavalent was identified and the apparatus was ready. The spectrophotometer measurement method was direct.

### Results

Caustic leaching is currently the preferred method for treating Hanford tank wastes (Rapko, et al., 2004). Caustic leaching is expected to remove large quantities of aluminate, phosphate, sulfate and chromium, which interfere with the immobilization of HLW glass. Chromium induces the formation of spinels in HLW glass. Spinel formation from the HLW glass could shorten the melter life by shorting electrodes, clogging the pour spout, or otherwise impacting melter life (Vienna et al., 2001).

Most importantly, chromium concentration in the HLW glass has the greatest influence on the volume of HLW glass production (Certa et al., 2004; and Perez et al., 2001). Therefore, diverting the maximum amount of chromium to the low-activity waste (LAW) stream has the greatest potential for shortening the processing time, possibly even by years. But from an industrial hygiene point of view, chromium removal may play an instrumental role in reducing the overall health risks to the public and to the workers by shortening processing time and therefore the time-at-risk. Once the waste has been converted to glass, the facility will be in a “safe harbor” condition.

Chromium hydroxides dissolve and oxidize readily in the presence of permanganate (Cr⁺³→Cr⁺⁶) in an alkaline state at a pH near 13 (or above) as the chemical reactions below indicate. The wastes are currently stored in this pH range to inhibit tank corrosion. Thus, little in the way of pH adjustment will be required during waste treatment. Therefore, the experiments conducted herein were controlled at a pH of near 13.

Sederburg and co-workers observed that, as the reaction between chromium and permanganate proceeds, 1 mole of Cr is leached from the simulant solution as 1 mole of solid MnO₂ is formed (Sederburg et al., 2003):

Cr(OH)₃+MnO₄⁻+OH⁻→CrO₄⁻²+MnO₂+2H₂O (44)

2Cr(OH)₃₍ₛ₎+3HO_{2 (aq)}⁻+OH⁻_{(aq)}→2CrO₄⁻²_{(aq)}+5H₂O (45)

MnO₂+2O₂+2H₂O+5e⁻→MnO₄⁻+4OH⁻ (46)

MnO₄⁻+8H⁺+5e⁻→Mn⁺²+4H₂O (pH<3.5) (47)

MnO₄⁻+2H₂O+3e⁻→MnO_{2 (s)}+4OH⁻ (pH 3.5 to 12) (48)

MnO₄⁻+e⁻⇄MnO₄⁻² (for pH>12) (49)

A broad range of oxidative leaching studies have recently been conducted on Hanford waste sludges (Rapko et al., 2005; Rapko et al., 2004; Lumetta et al., 2003; Lumetta et al., 2002; and Lumetta et al., 2001) because of the potential cost benefit. These studies recommend adding permanganate at a 1-to-1 ratio with the chromium concentration in the waste.

However, the oxidation approach using permanganate alone introduces several complications. For example permanganate adds Mn to the HLW glass stream resulting in an increase in glass produced; and permanganate oxidizes plutonium at a greater rate than other oxidants such as ozone and oxygen (Rapko et al., 2004, Table 1.3).

Therefore, to minimize the impacts of adding of large quantities of manganese in the form of permanganate, the methods of the present invention employ a combination of oxidants that, to an appreciable extent, reduces the mass of manganese left in the solids portion of the waste stream. The oxidative treatment methods of the present invention utilize peroxynitrite ion/peroxynitrous acid in combination with one or more additional oxidants, such as ozone and/or peroxide, and/or permanganate.

The oxidation methods illustrated in the following example were based upon simple binary interactions of chromium with single oxidants, at a constant pH of 13, and at a set of nitrate compositions that are typical of Hanford Tank waste process slurries in order to determine the various reaction mechanisms involved.

These “binary” experiments included: chromium hydroxide plus 254 nm UV light; chromium oxide plus 172 nm UV radiation; chromium oxide plus ozonated water; chromium hydroxide or chromium oxide plus hydrogen peroxide (H₂O₂); and chromium hydroxide or chromium oxide plus permanganate.

Further experiments were conducted that evaluated the combined or “ternary” system of two or three mixed oxidants and chromium according to the invention. These experiments included:
Chromium hydroxide plus peroxynitrite (generated from nitrate by 254 nm UV irradiation) plus gaseous ozone;
chromium oxide plus peroxynitrite (generated from nitrate by 172 nm UV irradiation);
chromium oxide plus ozonated water plus H₂O₂;
chromium oxide plus ozonated water plus H₂O₂ plus 172 nm UV irradiation;
chromium oxide plus ozonated water plus H₂O₂ plus peroxynitrite (generated from nitrate plus 172 nm UV irradiation);
chromium oxide plus ozonated water plus 172 nm UV irradiation;
chromium oxide plus ozonated water plus peroxynitrite (generated from nitrate plus 172 nm UV irradiation);
chromium oxide plus permanganate plus peroxide;
chromium oxide plus permanganate plus ozonated water plus peroxide;
chromium oxide plus ozonated water plus potassium permanganate plus 172 nm UV irradiation;
chromium oxide plus ozonated water plus potassium permanganate plus peroxynitrite (generated from nitrate plus 172 nm UV irradiation);
chromium oxide plus potassium permanganate plus 172 nm UV irradiation;
chromium oxide plus permanganate plus peroxynitrite (generated from 172 nm UV irradiation);
chromium oxide plus ozonated water plus potassium permanganate;
chromium hydroxide plus peroxynitrite (generated from nitrate irradiated by 254 nm UV) plus peroxide
chromium oxide plus peroxynitrite (generated from nitrate plus 172 nm UV) plus H₂O_{2;}
Chromium oxide plus peroxide plus 172 nm UV irradiation;
Chromium chloride plus ozonated water plus peroxynitrite (generated from nitrate irradiated by 172 nm UV);
Chromium potassium sulfate plus ozonated water plus peroxynitrite (generated from nitrate irradiated by 172 nm UV);
Chromium potassium sulfate plus ozonated water plus permanganate plus peroxynitrite (generated from nitrate irradiated by 172 nm UV);

Finally, experiments were conducted that also evaluated the combined effect of four mixed oxidants (254 nm UV-generated peroxynitrite plus peroxide plus permanganate plus gaseous ozone) for chromium oxidation.

Measurements were repeated and a standard error analysis was performed in each example. The data points presented in the Figures referred to below are connected by lines so that individual experiment sets can be readily compared to others. The lines serve no other purpose.

Chromium slurries were examined to determine the extent to which the alkaline chrome bearing solution would be oxidized in the presence of radiation alone. In the actual tank waste chemical system, the system is constantly irradiated by alpha, beta, and gamma radiation from actinides and fission products. The radiation together with constant exposure to air (via pumping of wastes, intrusive sampling, and constant ventilation) result in the continuing oxidation of the waste. In this study, a milder source of radiation was selected to provide a lower bound for the experimental baseline. A UV light (254 nm) was applied to a set of 0.3M Cr(OH)₃ solutions at a pH of ˜13 with a selected range of nitrate compositions. Under these conditions, the oxidation of chromium was determined to be a direct function of nitrate concentration. This result is due to the intermediate production of nitrate radicals (NO₃⁻) with peroxynitrite ion/peroxynitrous acid (ONOO—) as the end-product. The overall reaction scheme resulting from nitrate photolysis can be attributed to reaction (50) below (Mack and Bolton, 1999, Scheme 2, page 4):

NO₃⁻→hv_{(<280 nm)}→[NO₃⁻]*→ONOO⁻ (50)

The peroxynitrite ion/peroxynitrous acid (ONOO⁻) is the key reaction product. The reaction scheme of Mack and Bolton would apply to both the use of the 254 nm UV applied in the current experiments as well as to irradiation from the continuing radioactive decay of actinides and fission products in tank wastes.

Based on the recent experimental results (Rapko et al., 2004), the peroxynitrite ion/peroxynitrous acid (ONOO⁻) appears to be very effective in the oxidation of chromium with minimal oxidation of plutonium, even at 3M ONOO⁻.

The results with 172 nm UV were compared to theresults using a 254 nm lamp. In addition to creating peroxynitrite from nitrate, as shown in equation 50, this wavelength also creates hydroxyl radicals from water or hydroxide, shown in equation 51, and was therefore used to simulate this additional affect of the gamma radiation in the waste.

H₂O+hv_{(<190 nm)}→H.+OH.→O.⁻+H⁺+H. (51)

During the current baseline experiments (chromium+nitrate, 254 nm UV), trivalent chromium (greenish color) took on a coffee color on the surface as the UV radiation (254 nm) produced ONOO⁻ from nitrate resulting in the conversion of the trivalent chromium to the coffee-colored hexavalent chromium. Experiments conducted on radwaste simulants demonstrate that the chromium conversion mechanism is a consequence of UV irradiation of nitrate. Hanford tank waste (Rapko et al., 2004, Table 1.3) studies indicate that a 0.1M ONOO⁻ solution resulted in the removal of 60% of the chromium and only 0.7% removal of plutonium.

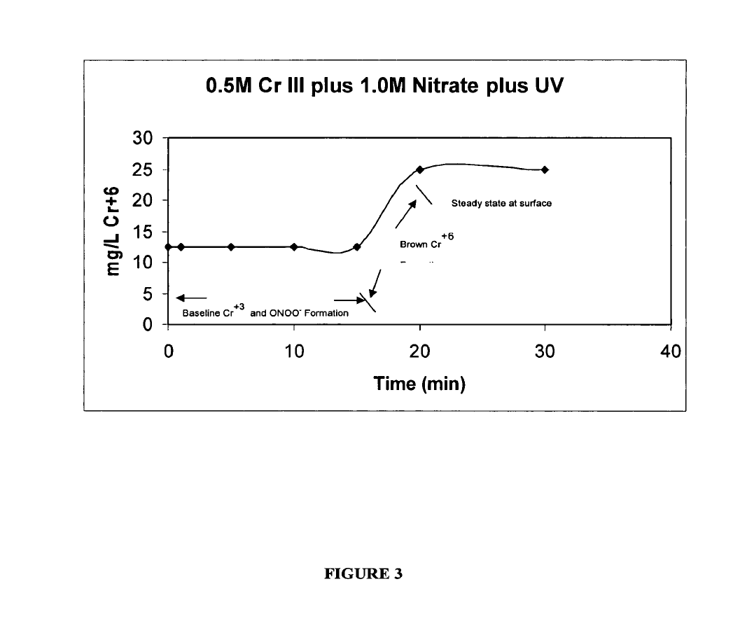

As shown in FIG. 3, there are three distinct measurement readings. During the first fifteen minutes the values for hexavalent chromium remain constant. During this time the oxidant, peroxynitrite is building up as noted previously in equation (50). The peroxynitrite subsequently reacts with the trivalent chromium resulting in the production of hexavalent chromium. The rate of reaction is a function of the intensity of the UV radiation, which depends on the distance of the lamp from the solution. It also depends on the ability of the mechanical mixing system to completely mix the surface reaction into the total volume of the reactor.

### Half Cell Potentials of Oxidants in Alkaline Solution

The following table provides some standard oxidation-reduction potentials of chemical reagents as they relate to this study.

| | | Volts/E° |
|---|---|---|
| | Redox Reaction | at 25° C. |
| 1. | Cr(OH)₃₍ₛ₎ + 1e⁻ → OH⁻_{(aq)} + Cr(OH)₂₍ₛ₎ | −1.9 |
| 2. | Cr(OH)₃₍ₛ₎ + 3e⁻ → 3OH⁻_{(aq)} + Cr(s) | −1.34 |
| 3. | Cr(OH)₂₍ₛ₎ + 2e⁻ → 2OH⁻_{(aq)} + Cr (s) | −1.41 |
| 4. | MnO₄⁻_{(aq)} + 4H₂O + 4e⁻ → 5OH−_{(aq)} + Mn(OH)₃₍ₛ₎ | +0.49 |
| 5. | MnO₄⁻_{(aq)} + 2H₂O + 3e⁻ → 4OH _{(aq)}⁻ + MnO₃₍ₛ₎ | +0.588 |
| 6. | MnO₄⁻ _{(aq)} + 4H + 3e⁻ → MnO₂₍ₛ₎ + 2H₂O | +1.68 |
| 7 | MnO₄ + e⁻ [symbol] MnO₄⁻ | (Siegrist, |
| | | et al., 2001). |
| 8 | O₃ + OH⁻ → HO_{2°} + O₂⁻ | (Siegrist, |
| | | et al., 2001) |
| 9. | (NO₃⁻)* → NO₂⁻ + O | (Shuali et |
| | | al. 1969) |
| 10. | O₃ + H₂O + 2e⁻ [symbol] ⁻2OH− + O₂ | +1.24 V |
| 11. | *HO₂− + H₂O + 2e⁻ [symbol] OH⁻ | +0.87 V |
| 12. | H₂O₂ + 2H⁺ + 2e− [symbol] H₂O | +1.776 V |

### Chromium Oxidation by Peroxide

In the following set of “binary” experiments (e.g., chromium+peroxide, etc.), it is clear that peroxide reacts rapidly with nitrate (when present) thereby, lowering its effectiveness in oxidizing chromium. The reaction of the peroxide (in excess) with the baseline simulant solution resulted in surface foaming due to the vigorous oxidation reactions and subsequent liberation of oxygen. The following sets of experiments were conducted over the range: 0.1, 0.3, and 0.5M peroxide. Nitrate clearly inhibited the oxidation reaction between peroxide and chromium. Instead of increasing the oxidation of chromium as in the case of chromium+UV experiments, the presence of nitrate in the chromium+peroxide experiments decreases chromium oxidation by peroxide.

The results of the previous experiments (FIG. 3) indicate that the application of UV at 254 nm, the peroxynitrite, alone, serves as a relatively weak oxidant. In fact, UV at 254 nm can act as a slightly reducing agent unless it reacts with oxidants like O₃ or H₂O₂ (Holland, 2004). By comparison, peroxide, permanganate, and ozone are much stronger oxidants. But, they react more vigorously with other solution species (CRC Handbook, 2004-2005) and lose some efficiency.

The following set of experiments illustrates the progressive effect of increasing nitrate concentration on the depression of chromium oxidation, in the absence of peroxynitrite generation.

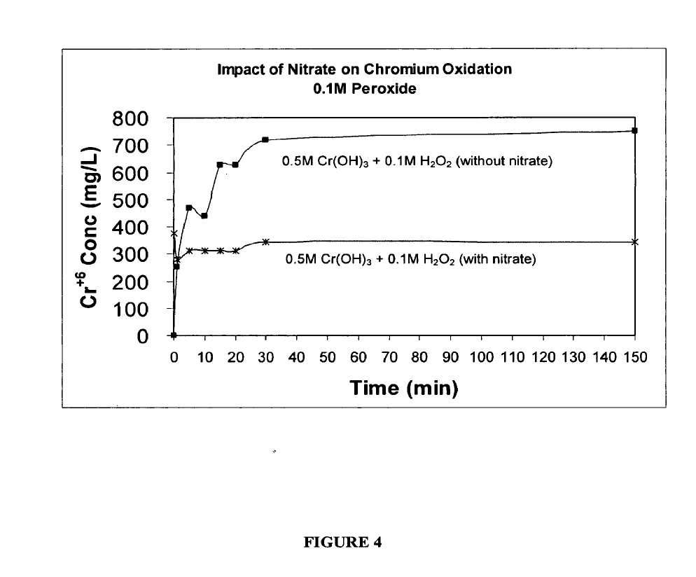

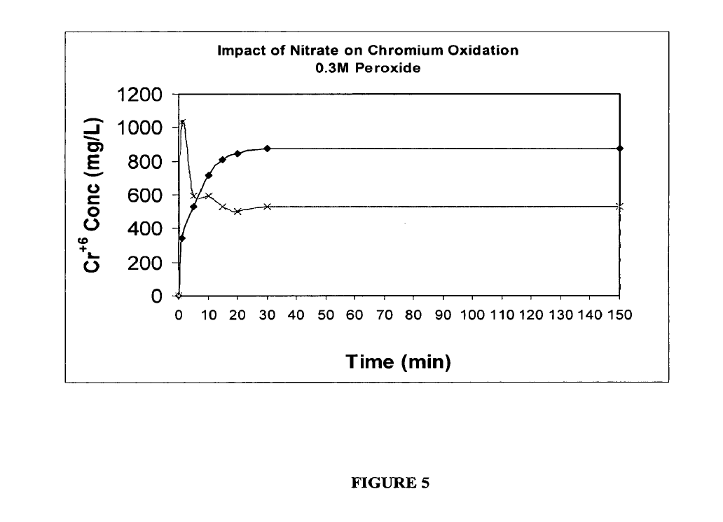

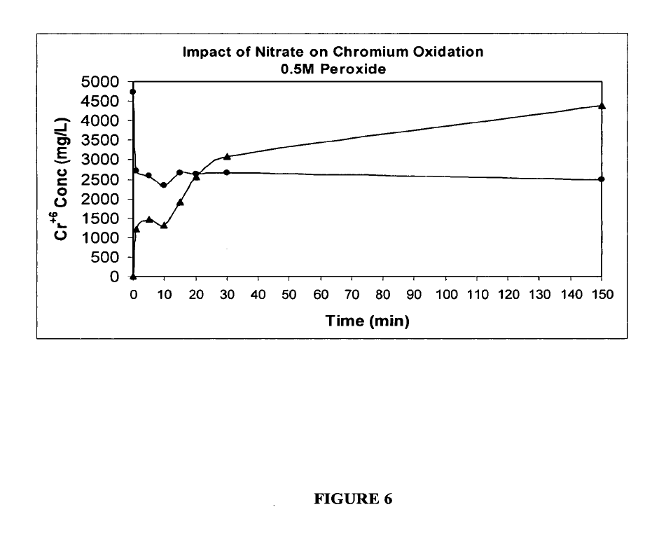

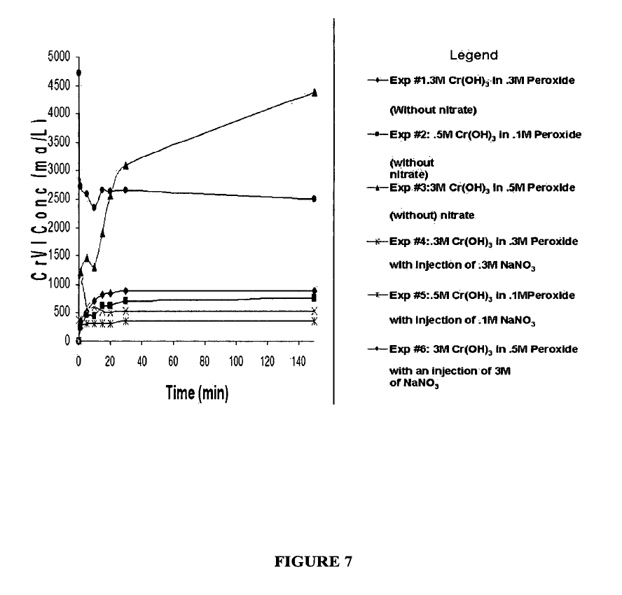

The summary of the depression of peroxide effectiveness due to the presence of nitrate (see FIGS. 4-7) illustrates that the concentration of Cr(OH)₃ is in direct proportion to the amount of Cr⁺⁶ produced in the 2.5 hour set of experiments. Note also that the trends were developed in about 40 minutes.

Competition reactions involving nitrate and nitrite ions are common in the radiolysis of radioactive slurries. The G-value for pure water is 0.45 H₂ molecules/100 eV. The measured values for the radiolysis of water progressively decrease as the nitrate+nitrite concentrations increase. This is due to the fact that the radiation energy is absorbed by the nitrogen solution species. Therefore, the presence of nitrates and nitrites in the Hanford tank wastes generally have an adverse effect by lowering the rate of oxidation of metal species. Therefore, current plans for treatment of Hanford wastes call for removal of nitrate and nitrite before the oxidation step.

### Chromium Oxidation by Permanganate

The oxidation of chromium by permanganate is the current approach preferred for the processing of Hanford tank wastes. The amount of chromium oxidized is directly proportional to the concentration of permanganate added to the waste stream. The following equation characterizes the reaction between chromium and permanganate.

Cr(OH)₃+MnO₄⁻+OH⁻←→CrO₄⁻²+MnO₂+2H₂O (52)

For each mole of chromium oxidized, one mole of permanganate is consumed. Therefore, the current project strategy is to add a slight excess of permanganate on a molar basis to oxidize chromium. However, recent results using this approach show that the reaction is incomplete (Rapko et al., 2004, Table 1.3).

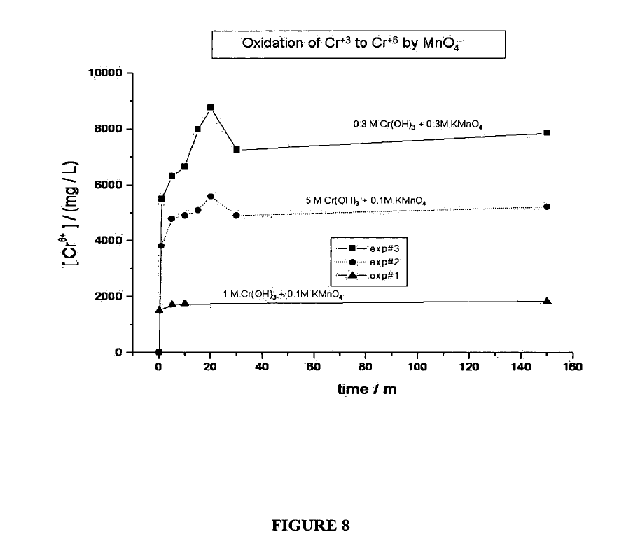

FIG. 8 illustrates that as the molar quantities of trivalent chromium are increased from 1.0M to 5M Cr(OH)₃ there is an increase in the amount of hexavalent chromium produced by permanganate oxidation. As expected, as the amount of permanganate is increased the production of hexavalent chromium is also increased.

### Le Chatlier's Principle and Nitrate Depression

When a reaction reaches equilibrium, it stays that way until something disturbs it. When a reaction is disturbed, the system will try to minimize whatever change was made to restore equilibrium. The concept that reactions can adjust when disturbed is called Le Chatlier's principle. There are three different ways that a reaction can be disturbed: change the concentration of the species, change the volume, or change the temperature.

In the current study, the photolysis of nitrate by UV at 254 nm is also suspected of producing nitrite (Mack and Bolton, 1999). The overall stoichiometry of the photolysis reaction is given in equation 52:

NO₃⁻+hv→NO₂⁻+½O₂ (53)

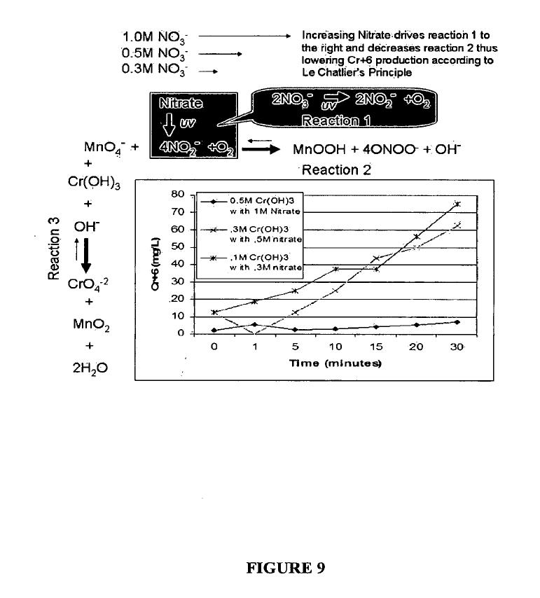

The reaction of nitrite plus oxygen with permanganate is given in equation (53). The redox reaction between the permanganate ion and the nitrite ion produce manganese hydroxide and peroxynitrite (as illustrated as Reaction 2, FIG. 9). Permanganate reacts with nitrite in an alkaline media according to composite equations (Reaction 1, FIG. 9) such as:

MnO₄⁻+4NO₂⁻+O₂+H₂O←→MnOOH+4ONOO⁻+OH⁻ (54)

MnOOH could also be balanced with other manganese species such as Mn(OH)_{3.}

As the concentration of nitrate (and therefore nitrite) increases due to Reaction 1, Reaction 2 shifts to the right (FIG. 9). As the concentration of nitrate increases (in this case from 0.3M to 1.0M nitrate) the shift to the right increases in response. If Reaction 2 shifts to the right (FIG. 9), then the effectiveness of permanganate to oxidize chromium in Reaction 3 (FIG. 9) is diminished. This results because the permanganate that is reacting with the nitrite is unavailable to react with chrome (III).

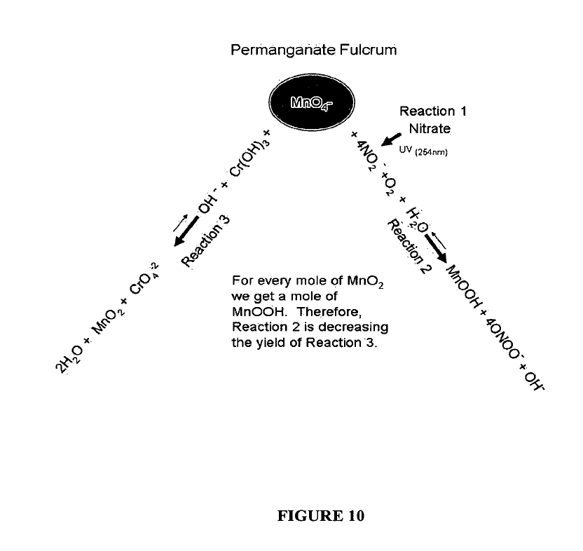

The relationship between the two reactions that govern the permanganate and nitrate interactions in the experiments can be looked upon as a fulcrum. The desired reaction (reaction 3, FIG. 9) that is designed to produce hexavalent chromium is offset by the competing reaction (reaction 2, FIG. 9) between nitrite and permanganate. As can be seen in FIG. 10, the photolysis of nitrate produces nitrite and shifts the reaction towards the production of manganese hydroxide in accordance with Le Chatlier's principle.

From a process chemistry point of view, this point underscores the necessity of removing the nitrate and nitrite salts in the actual radioactive wastes before using permanganate to oxidize trivalent chromium. Even with sludge washing, a considerable quantity of residual nitrite and nitrate salts are likely to remain because the washing process isn't entirely effective.

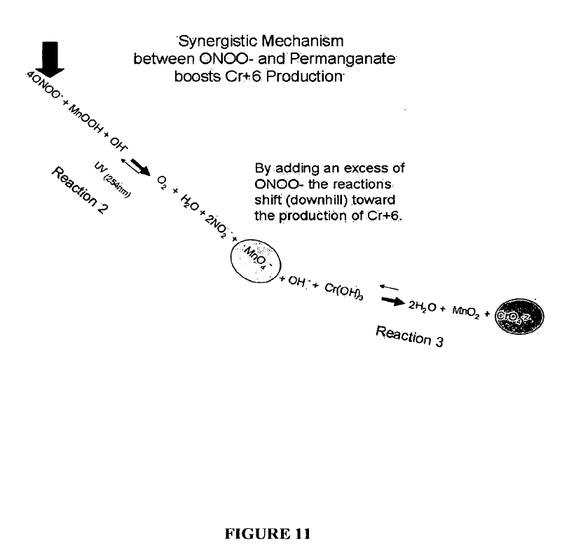

Therefore, the use of a mixed oxidant approach of the present invention is particularly advantageous. By adding a substantial quantity of peroxynitrite to the washed sludge, the two governing reactions will be tilted towards the production of hexavalent chromium as illustrated in FIGS. 10 and 11.

Peroxynitrite offers a number of major advantages. First, nitrate is already present in typical Hanford waste, and is therefore compatible with the current waste stream. More importantly, peroxynitrite will bypass the melter stream and be released from the off-gas system of the treatment process, and thus will not add to the mass of the glass produced in the vitrification process.

### Chromium Oxidation by Peroxynitrite Plus Peroxide

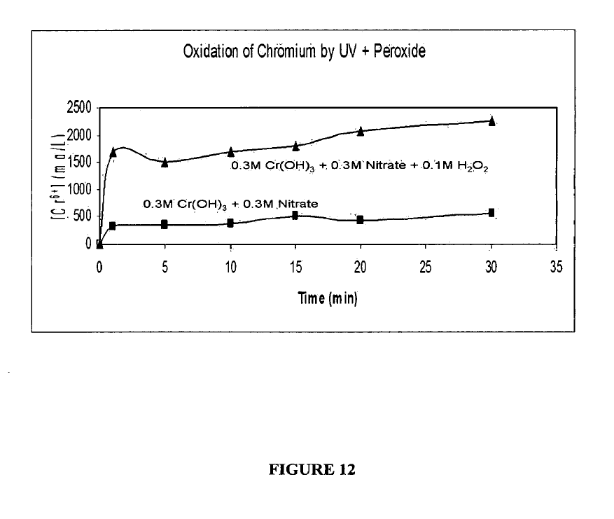

Chromium solutions were examined to determine the effects of peroxide plus UV in the presence and absence of nitrate, as shown in FIG. 12. Many advanced oxidation technologies utilize the UV photolysis of H₂O₂ to produce hydroxyl radicals as illustrated in equation 54 (Mack and Bolton, 1999):

H₂O₂→hv_{(<280 nm)}→2.OH (55)

It had been previously postulated that absorption spectra of NO₂⁻ and NO₃⁻ are dominated by intense π→π* bands at 205 and 200 nm. According to Mack and Bolton (1999) the presence of these anions could result in a significant “inner filter” effect that could reduce the fraction of the incident UV flux absorbed by H₂O₂. They also note that the photolysis of NO₂⁻ and NO₃⁻ is also known to result in the formation of hydroxyl radicals (OH.).

### Chromium Oxidation by Peroxynitrite Plus Ozone

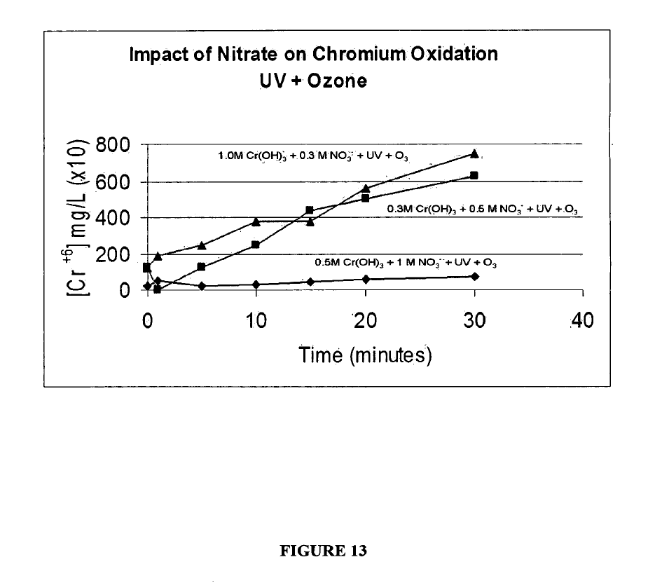

Nitrate concentration was found to also have an impact in the reactions of ozone used in conjunction with UV brought about similar results to those of other single strong oxidants (see FIG. 13). In the UV (254 nm) generated peroxynitrite plus ozone studies the trend again reversed when compared to the oxidation of chromium with only UV at 254 nm. Ozone, like permanganate and peroxide, is a strong oxidant and reacts readily with the nitrate species in solution. As a result, the effectiveness of ozone likewise appears to be depressed. Ozone is a moderate one-electron oxidant. For faster reactions, rapid mixing static-flow techniques would become necessary. This does not appear to lend itself well to the tank waste process facility design. Effective use of ozone would require much higher flow rates than in the experimental approach.

The benefit of introducing ozone (O₃) gas into Hanford waste to oxidize chromium is that it adds an insignificant mass to the amount of HLW glass product. Gaseous ozone is difficult to apply to a moving waste stream, however. Without extended contact of ozone with the waste solution by constant injection and mixing the approach appears to be ineffective for incorporation into the tank waste processing design. Modification would be required to enable constant mixing in the pretreatment facility. The potential window for this option has already been missed.

However, introduction of ozone as a saturated aqueous solution overcomes these limitations. The major drawback with the application of ozone (used as a single oxidant and introduced as a gas) is that its use would require new equipment and safety process evaluations, which would be a burden to the design process and extend the schedule of the project. The introduction of ozone dissolved in an aqueous medium, in combination with peroxynitrite as a mixed oxidant, as provided by the present invention affords considerable advantages.

The benefit of using hydrogen peroxide (H₂O₂) to oxidize chromium is that it adds an insignificant mass to the amount of HLW glass product. The major drawback to the application of peroxide to oxidize chromium in radwaste slurries is that it typically produces foaming (Rapko et al., 2004). Foaming requires the addition of anti-foaming agents to the process stream. The amount of peroxide consumed is proportional to the concentration of nitrate in the solution. Therefore, as the nitrate concentration increases the effectiveness of peroxide to oxidize chromium is decreased, in the absence of UV irradiation. Again, if peroxide is used in the methods of the present invention, it is preferably introduced with a second oxidant such as permanganate or ozone (mixed oxidant). This would reduce the required concentration of peroxide and reduce or even overcome the foaming issue.

### Progressive Oxidation of Chromium by Single and Mixed Oxidants

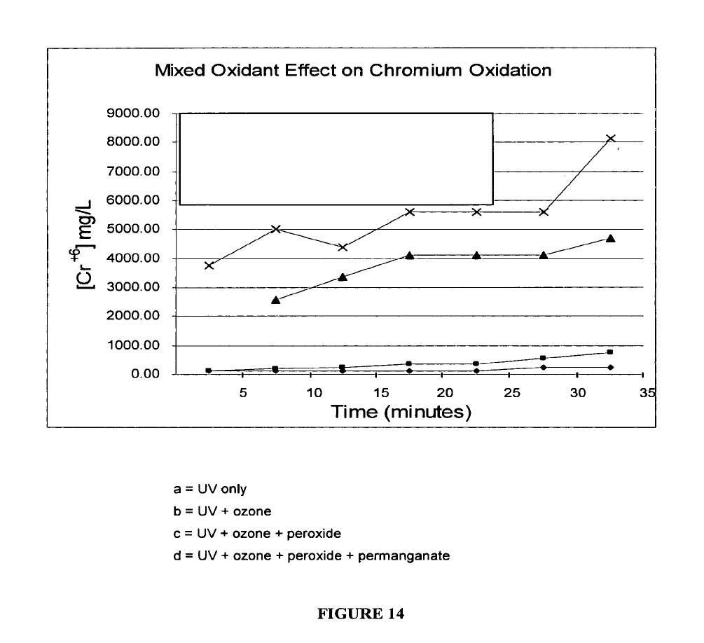

The progressive oxidation of chromium by single, binary, ternary, and quaternary mixtures of oxidants is illustrated in FIG. 14. Permanganate becomes an effective oxidizer for chromium, particularly when all three oxidizers are working at the same time; better reactions are formed and more Cr⁺⁶ is produced.

The results suggest that a mixed oxidant approach, as provided by the present invention has several clear advantages to the use of a single oxidant. Depression of the effectiveness of oxidants comes primarily from reactive solution species that consume other oxidants. These species include nitrogen species, other reduced metals found in abundance in the tank waste slurries, and organics.

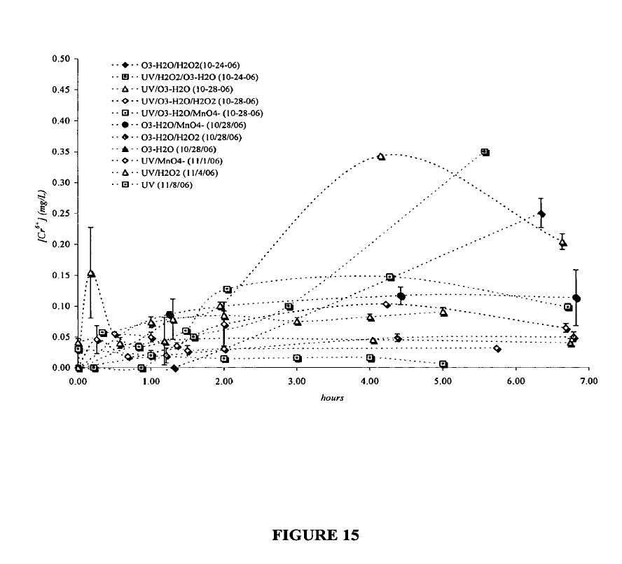

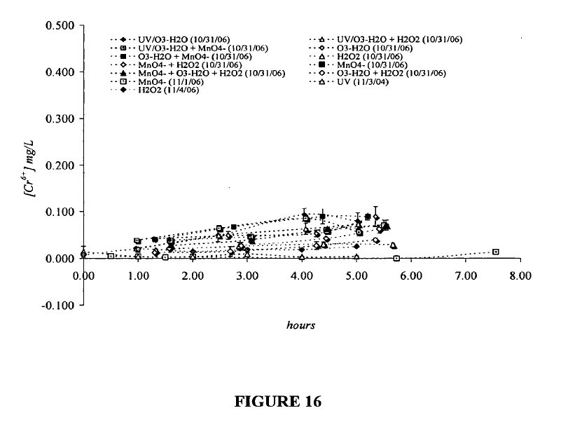

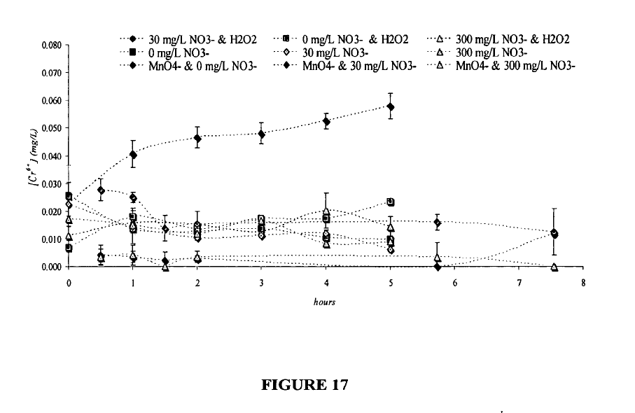

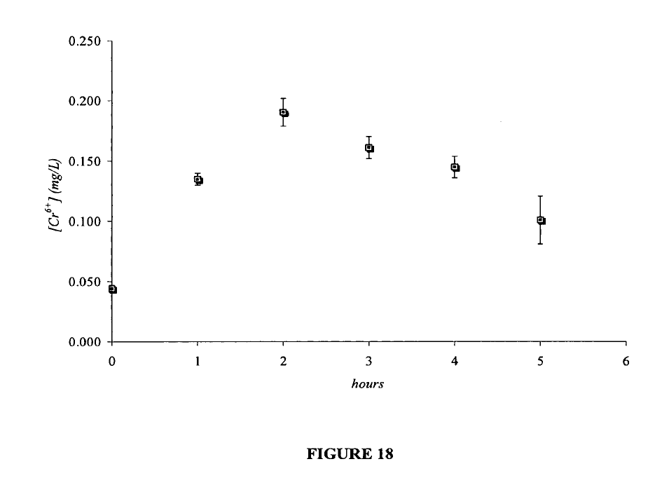

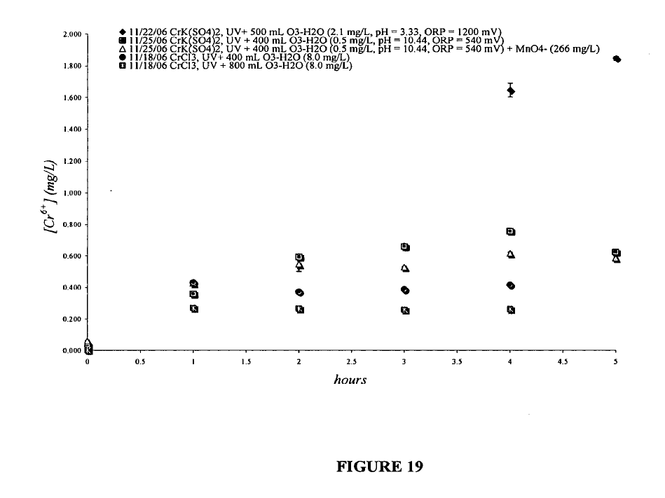

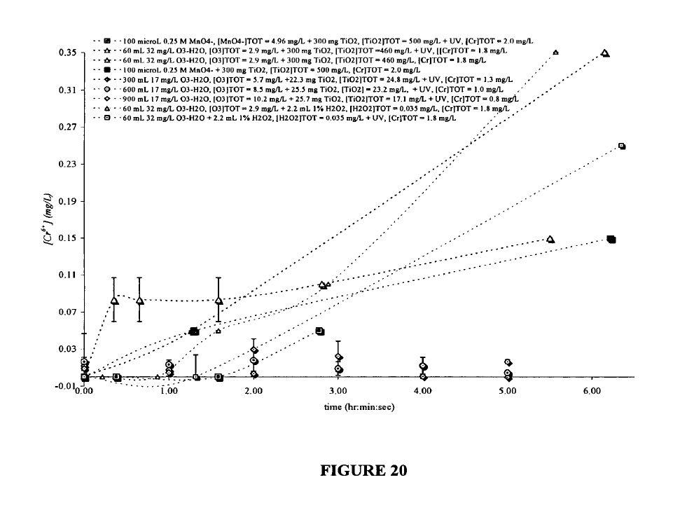

Results of further experiments are shown in FIGS. 15 through 20. In these experiments, ozone was applied as a solution of ozonated water. Data indicate that, as shown primarily in FIGS. 15 and 19, the combination of ozonated water and peroxynitrite (produced from nitrate by 172 nm light) in the presence of water or hydroxide oxidizing radiation is the most effective combination of oxidants for the oxidation of chromium (III) to (VI). The addition of permanganate appears to suppress the effectiveness of ozonated water. The addition of titanium dioxide photocatalyst may either suppress or enhance oxidation reactions, dependent on the dose added, through production of further hydroxyl radicals, shown in equation 52.

>TiO₂+hn_{<360}+OH⁻→>TiO₂⁺+OH⁻ (56)

Based on the above results, it is apparent that the mixed oxidants can overcome major drawbacks with the application of permanganate (used as a single oxidant), allowing for the use of lower permanganate levels.

Another major drawback with the application of permanganate (used as a single oxidant) is that it enhances plutonium dissolution. If the hydroxide concentration is 3M or greater, plutonium solubility ranges up to 69%. Plutonium solubility remains low if the oxidative leaching process includes less than 0.25M NaOH (Rapko et al, 2004). The oxidation of trivalent chromium by permanganate consumes considerable hydroxide (when applied as a single oxidant). An excess of hydroxide, required for the use of permanganate (as a single oxidant), enhances plutonium dissolution (Rapko et al, 2004).

The use of a 1.1M permanganate per mole of chromium in typical radwaste slurries leaves a residual of chromium in the range of about 0.5 wt % (Rapko et al, 2004). As the concentration of nitrate increases, the effectiveness of permanganate (as a single oxidant) decreases. The oxidation of chromium in Hanford radwaste slurries must account for nitrate concentration.

The application of UV at 254 nm in nitrate bearing slurries produces nitrate radicals, which form the peroxynitrite anion (ONOO⁻), which in turn oxidizes chromium. The amount of peroxynitrite formed by UV photolysis increases as the concentration of nitrate increases in the solution and as the UV intensity is increased by shortening the distance between the light source and the solution.

The peroxynitrite formed as a result of UV photolysis of radwaste nitrate solutions need not be generated in the process stream. The peroxynitrite ion/peroxynitrous acid can be generated outside of the current operation (ex situ) and then combined with additional oxidants, such as permanganate, ozone, or hydrogen peroxide, to achieve synergistic results. When used in combination with permanganate, peroxynitrite can substantially reduce the amount of manganese used, thereby reducing the quantity of HLW glass produced.

The mixed oxidant combination of peroxynitrite and permanganate has substantial advantages over the application of permanganate alone. For example, addition of the mixed-oxidant peroxynitrite-permanganate does not require any design changes beyond that already established for permanganate. The mixed-oxidant would be introduced into the system at the same location and in the same manner as previously intended for the introduction of permanganate. The primary advantage of the use of the mixed-oxidant peroxynitrite-permanganate is that it greatly reduces the mass otherwise added to the HLW Vitrification stream by permanganate alone by as much as a factor of 10 (3M to 0.25M). Another major benefit of the application of the mixed-oxidant peroxynitrite-permanganate is that it has the potential to greatly reduce plutonium dissolution compared to permanganate employed as a single oxidant. Peroxynitrite (itself) has no impact on the mass of solids received at the HLW melter while permanganate adds manganous hydroxide. Peroxynitrite, and hence the mixed-oxidant (peroxynitrite-permanganate), requires less hydroxide than permanganate. Peroxynitrite, used as a single oxidant, also compares well with the use of permanganate (Rapko et al, 2004).

A mixed oxidant approach of the present invention thus offers a substantial advantage over the use of permanganate alone. The application of mixed oxidants provides the opportunity to reduce the overall costs and risks of operations by shortening the time of waste process operations. More importantly, mixed oxidants can have minimal impact to glass formulation, by reducing or eliminating metals such as manganese. Hence the quantity of HLW glass produced will be reduced.

### REFERENCES

Alexander D. H, (1995). Method for separating constituents from solution employing a recyclable Lewis acid metal-hydroxyl gel. U.S. Pat. No. 5,547,583. Developed for the US Department of Energy—Washington D.C.

Anderson J. D, Mudd O. C. (1979). A History of 200 Area Tank Farms report. Prepared for the US Department of d Mudd O. C. 1979 Energy by Rockwell Hanford Operations. Richland, Wash. DE-AC06-77RL01030, revised and republished by Westinghouse Hanford Company DE-AC06-87RL-10930.

ASDR, (2002 update). Agency for Toxic Substances and Disease Registry. Toxicological profile for Chromium. U.S. Department of Health and Human Services/Centers for Disease Control and Prevention. Atlanta, Ga.

Balsey, S. D., J. L. Krumhansl, D. J. Borns, and R. G. McKeen (1997). Stabilization of In-Tank Residual Wastes and External-Tank Soil Contamination for the Tank Focus Area, Hanford Tank Initiative: Application to the AX Tank Farm. Sandia National Laboratories, Albuquerque, N. Mex.

Bechtel National Inc, CCN-11073, (2005). The Thermodynamic Flowsheet Results for the Oxidative Leach Process. Richland, Wash.

Bechtel National Inc, CCN-092312, (2005). Reconciliation of Tank 241-AZ-101 Waste Characterization Data; Supersedes CCN 087367. Richland, Wash.

Bechtel National Inc, (2005). Technical Report on Oxidative Leaching-Contract 24590-WTP-RPT-ENG-05006. Rev. 0. Richland, Wash.

Bidstrup, P. L, (1951). Carcinoma of the Lung in Chromate Workers Brit. J. Indstr. Med., 1951:8, 302.

Bidstrup, P. L. and Case, R. A. M (1956). Carcinoma of the Lung in the Dichromates-Producing Industry in the Great Britain. Brit. J. Indstr. Med., 1951:8, 302.

Boston H. L (2001). Hanford waste treatment complex foundation for success report. US Department of Energy Office of River Protection (USDOE/ORP). Richland, Wash. ORP-7664-FP Rev 0 and DOE Contract #AC06-96RL132001.

Boomer, K. D., S. Baker, A. Boldt, J. Galbraith, J. Garfield, Golberg, B. Higly, L. Johnson, M. Kupfer, R. Marusich, R. Parazin, A. Praga, G. Reddick, E. Slaathaugh, T. Waldo, and C. Worcester, (1993). Tank Waste Technical Options Report. WHC-EP-0616, Rev. 0. Westinghouse Hanford Company. Richland, Wash. March 1993.

Bolton, J. R., and Mack, J. (1999). Photochemistry of nitrite and nitrate in aqueous solution: a review. Journal of Photochemistry and Photobiology A: Chemistry 128 (1999) 1-13.

Brown, Valerie. (2003). Hanford Vitrification. Env. Sci. Tech. 37 (1) 6A-17A. 2003

Buerge, I. J and Hug, S. J. (1997). Kinetics and pH dependence of Chromium(VI) Reduction by Iron(II). Environ. Sci. Technol. 1997. 31, 1426:1432.

Buerge I. J, Hug S. J. (1998). Influence of Organic Ligands on Chromium (VI) Reduction by Iron (II). Environ. Sci. Technol. 1998, 32, 2092-2099.

Burger. J (1995). A risk Assessment for Lead in Birds. J. Toxically. Env. Health. 45:101-128.

Burger J. and Gochfeld. M. (1995). Growth and behavioral effects of early postnatal chromium and manganese exposure in herring gull (Larus argentatus) Chicks. Pharm. Biochem. Behav. 50:607-612.

Cadman, Theodore W, and Dellinger Robert W. (1980). Techniques for Removing Metals From Process Wastewater. Industrial Wastewater and Solid Waste Engineering—Chemical Engineering Magazine, pp 109-115-McGraw-Hill Publications co, New York. N.Y. USA

Cohen, M. D., Zelikoff, J. T, Chen, Lun-Chi., Schlesinger, R. B. (1998). Immunotoxicologic Effect of Inhaled Chromium: Role of Particle Solubility and Co-Exposure to Ozone. Toxicology and Applied Pharmacology 152, 30-40.

Cox, B. III and Linton, R. W. (1985). Determination of Chromium Speciation in Environmental Particles, Technique study of Ferrochrome Smelter dust. Environ. Sci. Technol. 1985. 19, 345-352.

CRC Handbook of Chemistry and Physics; 85th Ed.; CRC Press: Boca Raton, 2004/05.

Cotton, Albert F., G. Wilkinson, C. A Murillo, and M. Bochmann (1999). Advanced Inorganic Chemistry 6th ed., John Wiley & Sons, Inc. New York.

Colson, S. D., R. E. Gephart, V. L. Hunter, J. Janata, and L. G. Morgan. (1997 April). A Risk-Based Focused Decision-Management Approach for Justifying Characterization of Hanford Tank Waste: Revision 2. Pacific Northwest National Laboratory PNNL-11231, Richland, Wash.

Davis, C. M., Sumrall, K. H., and Vincent, J. B (1992) A biologically active form of chromium may activate a member phosphotyrosine phosphatase (PTP). Biochemistry 35:12963-12969.

Daneshvar, N., Salari, and Aber S. (2002). Chromium adoption and Cr(VI) reduction to trivalent chromium in aqueous solutions by soya cake. Journal of Hazardous Materials B94. 2000-49-61.

Delegard, C. H, A. M. Stubbs, and S. D, Bolling, (1993). Laboratory Testing of Ozone Oxidation of Hanford site Waste from Tank 241-SY-101. WHC-EP-0701, Westinghouse Hanford Company, Richland. Wash.

DOE. (1984). U.S Department of Energy. Environmental Protection, Safety, and Health Protection Standards. DOE Order 5480.4, Washington, D.C.

DOE. (1996). US Department of Energy, Office of Civilian Radioactive Waste Management Nuclear Waste Policy Act (Section 113)—Site Characterization Progress Report: Yucca Mountain, Nev. DOE/RW-0498 No. 15. Washington D.C.

DOE. (1998a). Report to Congress—Treatment and Immobilization of Hanford Radioactive Tank Waste Authorization-To-Proceed, Rev. 3. U.S. Department of Energy. Richland, Wash. May 1998.

DOE. (1998b). US Department of Energy (USDOE). Hanford Site Tank Waste Remediation System Programmatic Environmental Review Report. Richland, Wash., DOE-RL98-54 Rev. 0.

DOE, (1998b). US Department of Energy (USDOE). Hanford Site Tank Waste Remediation System Programmatic Environmental Review Report. Richland, Wash., DOE-RL98-54 Rev. 0.

DOE-HFFAAC, (1990). Hanford Facility Agreement and Consent Order, Amendment 3, Change Form M-17-91-05. March, 1992.

DOE/ORP. (2000). U.S Department of Energy/Office of River Protection. Design and Construction of the Hanford Tank Waste Treatment and Immobilization—Richland, Wash., DE-RP27-00RV14136.

Donohue, J. M., Gordon, L., Kirman, C., Roberts, W. C and Abernathy, C. (1994). Zinc Chloride and other Zinc Compounds. Drinking Water Health Advisory: Munitions II. Edited by Hartley W. R. Tulane School of Public Health and Tropical Medicine, Environmental Health Sciences.

Englande, A. J. and Reimers, R. S (1978). Capability of Wastewater Treatment Processes for Heavy Metals Removal. Department of Environmental Health Sciences. Tulane University School of Public Health and Tropical Medicine. New Orleans.

Fendorf, S. E and Zasoski, R. (1992). Chromium(III) Oxidation by δ-MnO2 1. Characterization. Environ. Sci. Technol. Vol. 26. No. 1, 1992.

Fendorf, S. C and Li, G. Kinetics of Chromate Reduction by Ferrous Iron. (1996). Environ. Sci. Technol. 1996. 30, 1614-1617.

Fleischman S. C. (1993). “Apparatus and Method for Two-Stage Oxidation of waste” U.S. Pat. No. 8,127,364. Pacific Northwest National Laboratory (PNNL). Richland, Wash.

Garrick B. J, Bier V. M, Croff A. G. (1999). An End State Methodology for Identifying Technology needs for Environmental Management with Example from the Hanford Site Tanks Report the National Academies Press.

Goheen S. C, Campbell J. A, and E. W. Hoppe. (2001a). Regulatory Analysis on glass product from C-104 and AZ-102 pretreatment HLW sludge mixed with flow sheet quantities of secondary wastes report prepared for CH2M Hill Hanford Group, Inc by Pacific Northwest National Laboratory. Richland, Wash. WTC-RPT-010, Rev 0, (formerly BNFL-RPT-047).

Goheen S. C, Campbell J. A, Hoppe E. W, Klinger G. S. (2001b). Regulatory analysis on product form AW-101 and AN-107 LAW pretreated report prepared for CH2M Hill Hanford Group, Inc by Pacific Northwest National Laboratory. Richland, Wash. WTC-RPT-005, Rev 0, (formerly BNFL-RPT-041).

Georgeton, G. K. (1994). Characterization of Hazardous Constituents in HLW Supernate and Implication for Solid LLW Generation Report. Westinghouse Savannah River Site. Aiken, S.C. WSRC-TR 94-0297 Rev 1.

Giletto, A., White, W., Cisar, A. J., Hitchens, G. D., Fyffe, J. (2003). Reactive Decontamination Formulation U.S. Pat. No. 6,569,353 Developed by Lynntech, Inc., College Station, Tex.

Glaze W. H., and Kang, J. W. (1989b). Advanced Oxidation Process—Description of a Kinetic Test of a kinetic Model for the Oxidation Organic Compound with Ozone and Hydrogen Peroxide in Semibatch Reactor. Ind. Eng. Chem. Res. 1989b, 28, 1580-1587.

Hartley, W. R (1994) Hartley, W. R., Roberts, W. C., Commons, B. J. Drinking Water Health Advisory: Munitions II PAS Publication Pg xi-xvii.

Hartman, M. J., Hartman, M. J., and Dressel, P. E. (1997). Hanford Site Groundwater Monitoring for Fiscal Year 1997 Report. US Department of Energy Richland, Washington State—DOE Contract #AC06-76RL01830.

Hazelwood K. J, Drake P. L, Ashley K, and Marcy D., (2004). Field Method for the Determination of Insoluble or Total Hexavalent Chromium in Workplace Air. Journal of Occupational and Environmental Hygiene, 1: 6i3-619.

Heckmann, E. E III. (1978). Toxic Chemicals: Destruction and waste Treatment. Ndc, Noyes Data Corp. New York, USA. July 1978.

Hewlett, R. G., and Holl, Jack M. (1989). Atom for Peace and War, 1953-1961: Eisenhower and The Atomic Energy Commission (Book). University of California Press, Berkeley Calif.

Holland. J. E, (2005). Ph. D. Dissertation; Development of a Nebulizing Advanced Oxidation Process, Tulane University. December 2004, New Orleans. La.

Icopini, G. A, and Long, D. T. (2002). Speciation of Aqueous Chromium by Use of Solid-Phase Extractions in the Field. Environ. Sci. Technol. 36. 2994-2999.

Kawanshi, S., Inoue, S., and Sano, S. (1986). Mechanism of DNA Cleavage Induced by Sodium Chromate in the Presence of Hydrogen Peroxide. J. Biol. Chem. 1986. 261, 5952-5958.

Krot, N. N, Shilov, V. P, Fedoseev, A. M, Budantseva, (1999). Development of Alkaline oxidative Dissolution Methods for Cr(III) Compounds Present in Hanford Site Tank Sludges. PNNL-12209. Pacific Northwest National Laboratory. Richland, Wash. 99352

Kim, J. G et al., (2003) Kim, J. G., Dixon J. B et al (2003). Oxidation of Chromium(III) to Chromium(VI) by Manganese Oxides. Soil Science Society of America Journal (SSSAJ) 66:306-315 (2002).

Kirschner, M. J. and Sethna, R. H. (2001). Pulp bleaching method wherein an ozone bleaching waste stream is scrubbed to form an oxygen containing stream. U.S. Pat. No. 6,210,527. Developed by The BOC Group, Inc., New Providence, N.J.

Lanouette H. K., (1980). Heavy Metal Removal. Industrial Wastewater and Solid Waste Engineering (Chemical Engineering Magazine). McGraw-Hill Publications Co., New York, N.Y.

Lanouette H. K and Paulson E. G. (1976). Treatment of Heavy Metals in Waste Water. Pollution Engineering October 1976.

Lash L. D and Kominek E. G (1980). Primary-Waste Treatment Methods. Industrial Wastewater and Solid Waste Engineering (Chemical Engineering Magazine). McGraw-Hill Publications Co., New York, N.Y. 1980.

Lumetta G. J, Swanson, J. L, and Barker, S. A. (1995). Process Chemistry for Treatment of Hanford Tank Wastes—Chemical Pretreatment of Nuclear Waste for Disposal W. W. Schutz and E. P. Horwitz, eds, Plenum Press, NY.

Lumetta, G. J., Rapko, B. M., Liu, J., Temer, D. J., and R. D. Hunt. (1998). Washing and Caustic Leaching of Hanford Tanks Sludge: Results of FY 1998 Studies. Pacific Northwest National Laboratory. Richland Wash.

Lumetta, G. J, Rapko, B. M., Liu, J., and Temer, D. J. (1998b). Enhanced Sludge Washing for Pretreating Hanford Tank Sludges: Science and Technology for Disposal of Radioactive Tank Wastes. W. W Schultz, and N. J Lombard, eds., Plenum Press, NY. Pg. 203-218.

Lumetta G. J, Rapko, B. M, Syslvester, P., Rutherford, Jr., Gonzalez-Martin, and Kim, J. (2000). Leaching methods for Pretreating Hanford Tank Sludges. In: Proceedings from WM 2000, Tucson, Ariz., Feb. 27-Mar. 2, 2000.

Lytle, C. Mel., Lytle, F. W., Yang, N., Qian J. H., Hansen, D., Zayed, A., and N. Terry. (1998). Reduction of Cr(VI) by Wetland Plants: Potential for In Situ Heavy metal Detoxification. Env. Sci. Technol. 1998, 3087-3093.

Marqués, M. J., Salvador, A., Morales-Rubio, A. and Guardia, M. de la. (1998) Analytical Methodologies for Chromium Speciation in Solid Matrices: A Survey of Literature. Fresenius J. Anal. Chem. 1998. 362:239-248.

Murray R K. Granner D. K, and P. A. Mayes. (1993). Harper's Biochemistry, 23rd ed. East Norwalk, Conn.

Olaiya, C. O., Holland J. E., Alexander, D. H. and R. S. Reimers. (2005). Method for Oxidizing with Multiple Liquid Oxidants. Patent in Progress.

Olazabal, M. A, Nikolaidis N. P, Suib S. A, and J. M. Madariada J. M. (1997). Precipitation Equilibria of the Chromium(VI) Iron(III) System and Spectroscopic Characterization of the precipitates Environ. Sci. Technol. 1997, 37, 1426-1432.

Mertz, Walter (1974). Chromium as a Dietary Essential for Man. Proceedings of the 2nd International symposium on trace element metabolism in animals, held in Madison, Wis. USA. 1974.

Omotoso, O. E., Ivy, D. G., and R. Mikula. (1995). Characterization of Chromium Doped Tricalcium Silicate Using SEM/EDS, XRD and FTIR, journal of Hazardous Materials 42 (1995) 87-102

Patton, G. W, Chamnes, M. A, Abernethy, C. S., and C. C. McKinstry, (2001). Chromium Toxicity Test for Fall Chinook Salmon (Oncorhynchus tshawytscha) Using Hanford Site Groundwater: Onsite Early Life-Stage Toxicity Evaluation. Pacific Northwest National Laboratory. Richland, Wash. Contract #DE-AC06-76RLO1830.

Plumb, R. C, Ewards, J. O, and M. Herman. (1992). Problem of Concurrent Measurements of Peroxonitrite and Nitrate Contents. Analyst. October, 1992 Vol. 117.

Pourbaix M. (1974). Atlas of Electrochemical Equilibria in aqueous Solution, NACE, Houston, Tex.

Qafoku, N. P, Ainsworth, C. C, Szecsody, J. E., and O. S. Qafoku. (2003). Effect of Couple Dissolution and Redox Reactions on Cr(VI) aq Attenuation during Transport in the Sediments under Hyperalkaline Conditions. Environ. Sci. Technol. 2003 37:3640-3646.

Rai, D., Sass, M, and D. A. Moore. (1987). Chromium(III) Hydrolysis Constants and Solubility Chromium(III) Hydroxide. Inorg. Chem. 26:345-349.

Rai, D., Rao, L., Clark., S. B, and J. Hess. (2003). Speciation, Dissolution, and Redox Reactions of Chromium Relevant to Pretreatment and separation of High-Level Tank Waste. Pacific Northwest National Laboratory, Richland Wash.

Rapko, B. M, and J. D. Vienna. (2003). Selected Leaching of Chromium from Washed W 241-S-110 Hanford Tank Sludge. Separation Science and Technology (in Press).

Rapko, B. M, and J. D. Vienna. (2002). Selected Leaching of Chromium from Hanford Tanks Washed W 241-U-108. PNNL-14019, Pacific Northwest National Laboratory, Richland, Wash.

Rapko, B. M, Geeting, J. G. H., Skihov, and J. D. Vienna, J. D. (2004). Oxidative-Alkaline Leaching of Washed 241-SY-102 and 241-SX-101 Tank Sludges. (WTP-RPT-117, Rev 0). Pacific Northwest National Laboratory, Richland, Wash.

Rapko, B. M, Blanchard, D. L., Colton, R., Felmy, A., Liu, J. and G. J. Lumetta. (1996a) The Chemistry of Sludge Washing and Caustic Leaching Processes for selected Hanford Tank Wastes. PNNL-11089, Pacific Northwest National Laboratory, Richland, Wash.

Rapko, B. M., Lumetta, G. J. and M. J. Wagner (1996). Oxidative Dissolution of Chromium from Hanford Tank Sludges Under Alkaline Conditions. PNNL-11233, Pacific Northwest National laboratory, Richland, Wash.

Rapko, B., Lumetta, G. J., Vienna, J. D., and Fiskum, S. K. 2005. Oxidative-Alkaline Leaching of Washed SY-102 and Its Impact on Immobilized High Level Waste WTP-RPP-137. Pacific Northwest National Laboratory, Richland, Wash.

Roat-Malone R. (2002): Biological Chemistry. John Wiley and Sons, New York.

Sederburg, J. P. (April 2003). Hanford Tank Waste Oxidative Leach Behavior Analysis, RPP-15552, Rev. 0, Richland, Wash.

Siegrist, R. L., Urynowicsz, M. A, West, O. R, Crimi, M. L, and K. S. Lowe. (2003). Principles and Practices of In Situ Chemical Oxidation Using Permanganate Battelle Press Columbus, Richland USA.

Stumm W. and J. J. Morgan. (1996). Aquatic Chemistry-Chemical Equilibria: Chemical Equilibria and Rates of Natural Waters, 3rd ed., 1996. John Wiley and Sons Inc, New York

Sundaram, V. S. M., Fisher, S. A., Corbeil, S. (2001) Method to improve final bleached pulp strength properties by adjusting the CIO2:03 ration within a single (D/Z) stage of the bleaching process U.S. Pat. No. 6,174,409. Developed by American Air Liquide Inc., Walnut Creek, Calif.

Thornton, E. C., Amonette, J. E., Oliver, J. A., and D. L. Huang. (1995). Evaluation of Chromium Speciation and Transport Characteristics in the Hanford Site 100D and 100H Areas. Westinghouse Hanford Company and Pacific Northwest Laboratory Report prepared for the US Department of Energy, Richland, Wash. State. WHC-SA-2925-FP.

Toven, K., Gellerstedt, G., Kleppe, R., Moe, S. (2002). Use of chlorine dioxide and ozone in combination in prebleaching. J. of Pulp and Paper Science Vol. 28, No. 9, pp. 305-310

Vuorinen, T. J., Buchert, U. J., Teleman, A. B.-L. Tenkanen. T. M. (2004). Method of treating cellulosic pulp to remove hexenuronic acid. U.S. Pat. No. 6,776,876. Developed by Andritz Oy, Helsinki, Finland.

World Health Organization (1988). “Environmental Health Criteria 61”-Chromium. Published under the joint sponsorship of the United Nations Environmental Programme, the International Labour Organization, and the World Health Organization Geneva. 1988.

Zepp R. G et al, (1987). Zepp, R. G, Holgne J., Bader, H. Nitrate-induced Photooxidation of Traced Organic Chemicals in Water. Environ. Sci. Technol. Vol. 21, No, 5, 1987.

1. A method for oxidizing a substance comprising contacting the substance with peroxynitrite ion/peroxynitrous acid and at least one additional oxidizing agent in an amount and for a period of time sufficient to oxidize the substance.

2. The method of claim 1 wherein the at least one additional oxidizing agent comprises an oxidant selected from the group consisting of ozone, hydrogen peroxide, permanganate, ferrate, persulfate, an oxidizing halogen species, peroxyacetic acid, a perborate salt, a percarbonate salt, nitrogen dioxide, nitric acid, nitrogen monoxide, superoxide, atomic oxygen, hydroperoxyl radical, hydroxyl radical, sulfate radical, carbonate radical, nitrate radical, and a combination of two or more of the foregoing oxidants.

3-45. (canceled)

46. The method of claim 1 wherein the peroxynitrite ion/peroxynitrous acid is generated by irradiating nitrate ion/nitric acid with electromagnetic radiation having sufficient energy to generate a peroxynitrite species therefrom.

47. The method of claim 46 wherein the electromagnetic radiation is selected from the group consisting of ultraviolet radiation, gamma radiation, and any other form of ionizing radiation, the gamma radiation optionally emanating from a radioactive component present in the substance.

48. The method of claim 1 wherein at least a portion of the peroxynitrite ion/peroxynitrous acid is generated from nitrate ion/nitric acid ex situ of the substance.

49. The method of claim 1 wherein at least a portion of the peroxynitrite ion/peroxynitrous acid is generated from nitrate ion/nitric acid in situ in the substance.

50. The method of claim 46 wherein the electromagnetic radiation is directly applied to the substance to enhance oxidation reactions in addition to peroxynitrite ion/peroxynitrous acid production.

51. The method of claim 1 wherein a catalyst is added to enhance oxidation.

52. A method for purifying a waste stream containing a contaminant substance comprising:
contacting the waste stream, in an aqueous medium, with peroxynitrite ion/peroxynitrous acid and at least one additional oxidizing agent in an amount and for a period of time sufficient to oxidize the contaminant substance and form at least one oxidation product from the contaminant substance that is soluble in the aqueous medium; and removing the at least one oxidation product from the waste stream;
wherein the peroxynitrite ion/peroxynitrous acid optionally is generated by irradiating nitrate ion/nitric acid with electromagnetic radiation.

53. The method of claim 52 wherein the electromagnetic radiation is ultraviolet radiation.

54. The method of claim 52 wherein the electromagnetic radiation is gamma radiation, which optionally emanates from a radioactive component present in the waste stream.

55. The method of claim 52 wherein at least a portion of the peroxynitrite ion/peroxynitrous acid is generated from nitrate ion/nitric acid ex situ and is added to the waste stream thereafter.

56. The method of claim 52 wherein the contaminant substance is chromium present in the waste stream, the chromium-containing waste stream is contacted with the peroxynitrite ion/peroxynitrous acid and at least one additional oxidizing agent in an amount and for a period of time sufficient to oxidize at least one lower-valent chromium species present in the waste stream to form at least one chromium (+6) species that is soluble in the aqueous medium; and the at least one chromium (+6) species is removed from the waste stream.

57. The method of claim 56 wherein the chromium-containing waste stream is a high-level radioactive waste stream.

58. The method of claim 56 wherein the chromium-containing waste stream comprises waste particles that are insoluble in the aqueous medium.

59. The method of claim 58 wherein the at least one soluble chromium (+6) species is removed by separating the waste particles from the aqueous medium containing the at least one chromium (+6) species, the separating optionally being accomplished by filtration or by decanting the waste particles from the aqueous medium.

60. The method of claim 56 wherein the at least one additional oxidizing agent comprises ozone and hydrogen peroxide, optionally with a permanganate salt.

61. A method for purifying and disinfecting and/or sterilizing drinking water comprising:
contacting the drinking water with peroxynitrite ion/peroxynitrous acid and at least one additional oxidizing agent in an amount and for a period of time sufficient to oxidize at least one selected contaminant substance in the water and form at least one oxidation product from the contaminant substance, and to disinfect or sterilize the drinking water;
wherein the peroxynitrite ion/peroxynitrous acid optionally is generated by irradiating nitrate ion/nitric acid with electromagnetic radiation.

62. The method of claim 61 wherein the electromagnetic radiation is ultraviolet radiation.

63. A method for oxidizing and etching the surface of a substrate comprising:
contacting a surface of the substrate with peroxynitrite ion/peroxynitrous acid and at least one additional oxidizing agent in an amount and for a period of time sufficient to oxidize at least a portion of the surface, and removing the oxidized portion of the surface.

64. The method of claim 63 wherein the at least one additional oxidizing agent is selected based on the chemical properties of the surface to be oxidized and etched.

65. The method of claim 63 wherein the electromagnetic radiation is selected from the group consisting of ultraviolet radiation and gamma radiation.

66. A method for bleaching paper pulp comprising:
contacting a paper pulp slurry with peroxynitrite ion/peroxynitrous acid and at least one additional oxidizing agent in an amount and for a period of time sufficient to oxidize at least one colored contaminant species in the pulp slurry, thereby reducing the color of the paper pulp.
